(19) United States
(12) Patent Application Publication
(10) Pub. No.: US 2015/0348057 A1
(43) Pub. Date: Dec. 3, 2015

(54) Determination of a Customer Store Segment Sales Model

(71) Applicant: DecisionGPS. LLC, Irving, TX (US)

(72) Inventors: Ijaz Husain PARPIA, Southlake, TX (US); Gurdip SINGH, Coppell, TX (US)

(73) Assignee: DecisionGPS. LLC, Irving, TX (US)

(21) Appl. No.: 14/289,541

(22) Filed: May 28, 2014

(51) Int. Cl. G06Q 30/02

(52) U.S. Cl. CPC G06Q 30/0201; G06Q 30/0282

(57) ABSTRACT

A method comprising identifying a set of stores, the set of stores comprising information indicative of a plurality of stores, and each store of the set of stores comprising a set of store attributes, identifying a first set of customer attributes, segmenting the set of stores into a first set of customer store segments, identifying a first set of product attributes, generating a first set of product attribute sales summaries that comprises a product attribute sales summary for each customer store segment of the first set of customer store segments, determining a first distinctiveness rating for the product attribute sales summary for each customer store segment of the first set of customer store segments, and determining a customer store segment sales model based, at least in part, on the first set of customer store segments, the first set of product attribute sales summaries, and the first distinctiveness rating is disclosed.

### TECHNICAL FIELD

The present application relates generally to determination of a customer store segment sales model.

### BACKGROUND

In many circumstances, merchants, purchasers, and/or similar individuals or entities may desire to purchase merchandise, stock inventory, purchase goods, and/or the like. In such circumstances, it may be desirable to allow such a party to make informed and educated purchasing decisions.

### SUMMARY

Various aspects of examples of the invention are set out in the claims.

One or more embodiments may provide an apparatus, a computer readable medium, a non-transitory computer readable medium, a computer program product, and a method for identifying a set of stores, the set of stores comprising information indicative of a plurality of stores, and each store of the set of stores comprising a set of store attributes, identifying a first set of customer attributes, segmenting the set of stores into a first set of customer store segments based, at least in part, on correlation between each set of store attributes for each store of the set of stores and customer historical data that corresponds with the first set of customer attributes, such that each the customer store segment of the first set of customer store segments consists of stores that have at least one homogenous customer attribute, identifying a first set of product attributes, generating a first set of product attribute sales summaries that comprises a product attribute sales summary for each customer store segment of the first set of customer store segments, such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sale summaries, determining a first distinctiveness rating for the product attribute sales summary for each customer store segment of the first set of customer store segments, and determining a customer store segment sales model based, at least in part, on the first set of customer store segments, the first set of product attribute sales summaries, and the first distinctiveness rating.

One or more embodiments may provide an apparatus, a computer readable medium, a computer program product, and a non-transitory computer readable medium having means for identifying a set of stores, the set of stores comprising information indicative of a plurality of stores, and each store of the set of stores comprising a set of store attributes, means for identifying a first set of customer attributes, means for segmenting the set of stores into a first set of customer store segments based, at least in part, on correlation between each set of store attributes for each store of the set of stores and customer historical data that corresponds with the first set of customer attributes, such that each the customer store segment of the first set of customer store segments consists of stores that have at least one homogenous customer attribute, means for identifying a first set of product attributes, means for generating a first set of product attribute sales summaries that comprises a product attribute sales summary for each customer store segment of the first set of customer store segments, such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries, means for determining a first distinctiveness rating for the product attribute sales summary for each customer store segment of the first set of customer store segments, and means for determining a customer store segment sales model based, at least in part, on the first set of customer store segments, the first set of product attribute sales summaries, and the first distinctiveness rating.

In at least one example embodiment, a store attribute indicates at least one characteristic of a store associated with the store attribute.

In at least one example embodiment, the store attribute indicates at least one of a location of the associated store, a market region associated with the store, a size of the associated store, a revenue of the associated store, or an average transaction amount associated with the store.

In at least one example embodiment, a plurality of stores of the set of stores have a similar value for a particular store attribute.

In at least one example embodiment, the segmentation of the set of stores into a first set of customer store segments further comprises further segmentation such that each customer store segment of the first set of customer store segments consists of stores that have at least one homogenous customer attribute and at least one homogenous store attribute.

In at least one example embodiment, a product attribute is an attribute of a product that classifies the product within a merchandise category.

In at least one example embodiment, the identification of the quantity of sales associated with each product attribute of the first set of product attributes comprises grouping of products into a set of products that are associated with the product attribute, and determination of the quantity of sales associated with the set of products.

In at least one example embodiment, a customer attribute indicates a characteristic of a customer.

In at least one example embodiment, each customer attribute of the first set of customer attributes indicates an independent characteristic of a customer.

In at least one example embodiment, each customer attribute comprised by the first set of customer attributes is attributable to a variety of customers.

In at least one example embodiment, a plurality of customers represented by the customer historical data have a similar value for a particular customer attribute.

In at least one example embodiment, the customer historical data comprises information that indicates one or more values associated with one or more customer attributes associated with one or more customers.

In at least one example embodiment, the customer historical data comprises at least one of customer loyalty program data, syndicated market data, syndicated shopper data, demographic data, or lifestyle data.

One or more example embodiments further perform identification of sales information comprised by the customer historical data that corresponds with one or more customer attributes of the first set of customer attributes, wherein the correlation between each set of store attributes for each store of the set of stores and customer historical data that corresponds with the first set of customer attributes is based, at least in part, on the sales information.

In at least one example embodiment, the sales information may be indicative of at least one of specific customer transactions, anonymous customer transactions, or customer group transactions.

In at least one example embodiment, a customer group is a collective of members of a community that is presumed to shop at a store of the set of stores.

In at least one example embodiment, the customer historical data comprises a least one statistically accurate representation of a model customer.

In at least one example embodiment, each customer attribute comprised by the first set of customer attributes corresponds with personal data that is represented in customer historical data.

In at least one example embodiment, each customer attribute comprised by the first set of customer attributes is at least one of, a customer income range, a customer ethnicity, a customer age, a customer age range, a customer marital status, a customer dependent status, a customer gender, a customer interest, a customer religion status, or a customer housing status.

In at least one example embodiment, a store is at least one of a selling location or a fulfillment location.

In at least one example embodiment, the store is at least one of a selling location or a fulfillment location that exists in a retail channel.

In at least one example embodiment, a selling location is at least one of a physical store, a mail-order store, a telephone-order store, or an internet store.

In at least one example embodiment, a fulfillment location is at least one of a distribution location, an order fulfillment center, a warehouse location, a sales kiosk, or an order pick-up location.

In at least one example embodiment, a customer store segment identifies a collection of stores that are characterized by a predominant set of customer attributes.

In at least one example embodiment, the segmentation of the set of stores into the first set of customer store segments comprises determination of an average value for each customer attribute of the first set of customer attributes for each store of the set of stores based, at least in part, on the customer historical data, representation of each store of the set of stores as a data point to form a plurality of data points such that each customer attribute of the first set of customer attributes is an independent dimension of the data point, identification of a plurality of clusters of the plurality of data points, and determination that the first set of customer store segments comprises customer store segments that correspond with the plurality of clusters.

In at least one example embodiment, the customer historical data is associated with sales information of each store of the set of stores, and the determination of the average value for each customer attribute of the first set of customer attributes comprises identification of each customer attribute associated with the sales information.

In at least one example embodiment, the determination of the average value for each customer attribute of the first set of customer attributes comprises determination that a customer attribute of the first set of customer attributes is unrepresented by sales information of each store of the set of stores, identification of a secondary attribute that is represented by the sales information, identification of the customer historical data to be a set of data that represents the customer attribute in relation to the secondary attribute, and determination of the average value based, at least in part, on correlation between the secondary attribute and the customer attribute in the set of data.

In at least one example embodiment, the secondary attribute is location information associated with each store of the set of stores, and the set of data comprises census information.

In at least one example embodiment, identification of the plurality of clusters is based, at least in part, on at least one of k-means clustering, centroid-based clustering, hierarchical clustering, linkage clustering, E-M clustering, or distribution-based clustering.

In at least one example embodiment, each customer store segment of the first set of customer store segments is labeled to indicate one or more homogenous customer attribute of each store of the customer store segment.

In at least one example embodiment, the generation of the first set of product attribute sales summaries comprises identification of products that have a product attribute that corresponds with at least one of the product attributes of the first set of product attributes.

In at least one example embodiment, the distinctiveness rating indicates a variation of sales performance across each product attribute sales summary.

In at least one example embodiment, the determination of the first distinctiveness rating is based, at least in part, on an information gain for the product attributes of the first set of product attributes.

One or more example embodiments further perform identification of a second set of customer attributes, segmentation of the set of stores into a second set of customer store segments based, at least in part, on correlation between each store of the set of stores and customer historical data that corresponds with the second set of customer attributes, such that each the customer store segment of the second set of customer store segments consists of stores that have at least one homogenous customer attribute, generation of a second set of product attribute sales summaries that comprises a product attribute sales summary for each customer store segment of the second set of customer store segments, such that each product attribute sales summary of the second set of product attribute sales summaries identifies a quantity of sales associated with each product attribute of the first set of product attributes from each store within a customer store segment of the second set of customer store segments that is associated with the product attribute sales summary of the second set of product attribute sales summaries, and determination of a second distinctiveness rating for the product attribute sales summary for each customer store segment of the second set of customer store segments, wherein the determination of a customer store segment sales model is based, at least in part, on the second distinctiveness rating.

In at least one example embodiment, the determination of the customer store segment sales model comprises determination that the first distinctiveness rating is greater than the second distinctiveness rating, and determination of the customer store segment sales model to comprise the first set of customer store segments based, at least in part, on the determination that the first distinctiveness rating is greater than the second distinctiveness rating.

One or more example embodiments further perform identification of a second set of product attributes, generation of a second set of product attribute sales summaries that comprises a product attribute sales summary for each customer store segment of the first set of customer store segments, such that each product attribute sales summary of the second set of product attribute sales summaries identifies a quantity of sales associated with each product attribute of the second set of product attributes from each store within a customer store segment of the first set of customer store segments that is associated with the product attribute sales summary, and determination of a second distinctiveness rating for the product attribute sales summary for each customer store segment of the first set of customer store segments, wherein the determination of a customer store segment sales model is based, at least in part, on the second distinctiveness rating.

One or more example embodiments further perform identification of a second set of customer attributes, segmentation of the set of stores into a second set of customer store segments based, at least in part, on correlation between each store of the set of stores and customer historical data that corresponds with the second set of customer attributes, such that each the customer store segment of the second set of customer store segments consists of stores that have at least one homogenous customer attribute, identification of a second set of product attributes, generation of a second set of product attribute sales summaries that comprises a product attribute sales summary for each customer store segment of the second set of customer store segments, such that each product attribute sales summary of the second set of product attribute sales summaries identifies a quantity of sales associated with each product attribute of the second set of product attributes from each store within a customer store segment of the second set of customer store segments that is associated with the product attribute sales summary, and determination of a second distinctiveness rating for the product attribute sales summary for each customer store segment of the second set of customer store segments, wherein the determination of a customer store segment sales model is based, at least in part, on the second distinctiveness rating.

In at least one example embodiment, the generation of the first set of product attribute sales summaries excludes information indicative of discount priced sales.

In at least one example embodiment, the customer store segment sales model comprises product rate of sale information and product sales volume information.

In at least one example embodiment, each product attribute sales summary of the first set of product attribute sales summaries comprises rate of sale information and sales volume information.

In at least one example embodiment, the determination of the customer store segment sales model comprises normalization of product attribute sales summary sales volume information to generate the product sales volume information of the customer store segment sales model.

In at least one example embodiment, the normalization of the product attribute sales summary sales volume comprises normalization of the product attribute sales summary sales volume with respect to an aggregate sales volume associated with the customer store segment that is associated with the product sales attribute summary.

In at least one example embodiment, the rate of sale information identifies a number of sales associated with the first set of product attributes in relation to a predetermined period of time.

In at least one example embodiment, the customer store segment sales model is a data structure that correlates data between dimensions of the data structure.

In at least one example embodiment, the customer store segment sales model correlates each customer store segment of the first set of customer store segments with the product rate of sale information and the product sales volume information.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to at least one example embodiment;

FIGS. 2A-2B are diagrams illustrating a set of customer store segments according to at least one example embodiment;

FIGS. 3A-3E are diagrams illustrating a set of product attribute sales summaries and information associated with the set of product attribute sales summaries according to at least one example embodiment;

FIGS. 4A-4C are diagrams illustrating a set of product attribute sales summaries and information associated with the set of product attribute sales summaries according to at least one example embodiment;

FIGS. 5A-5E are diagrams illustrating a set of product attribute sales summaries and information associated with the set of product attribute sales summaries according to at least one example embodiment;

FIG. 6 is a flow diagram illustrating activities associated with determination of a customer store segment sales model according to at least one example embodiment;

FIG. 7 is a flow diagram illustrating activities associated with identification of a plurality of clusters according to at least one example embodiment;

FIG. 8 is a flow diagram illustrating activities associated with identification of a plurality of clusters according to at least one example embodiment;

FIG. 9 is a flow diagram illustrating activities associated with determination of a customer store segment sales model according to at least one example embodiment;

FIG. 10 is a flow diagram illustrating activities associated with determination of a customer store segment sales model according to at least one example embodiment;

FIG. 11 is a flow diagram illustrating activities associated with determination of a customer store segment sales model according to at least one example embodiment; and

FIG. 12 is a flow diagram illustrating activities associated with determination of a customer store segment sales model according to at least one example embodiment.

### DETAILED DESCRIPTION OF THE DRAWINGS

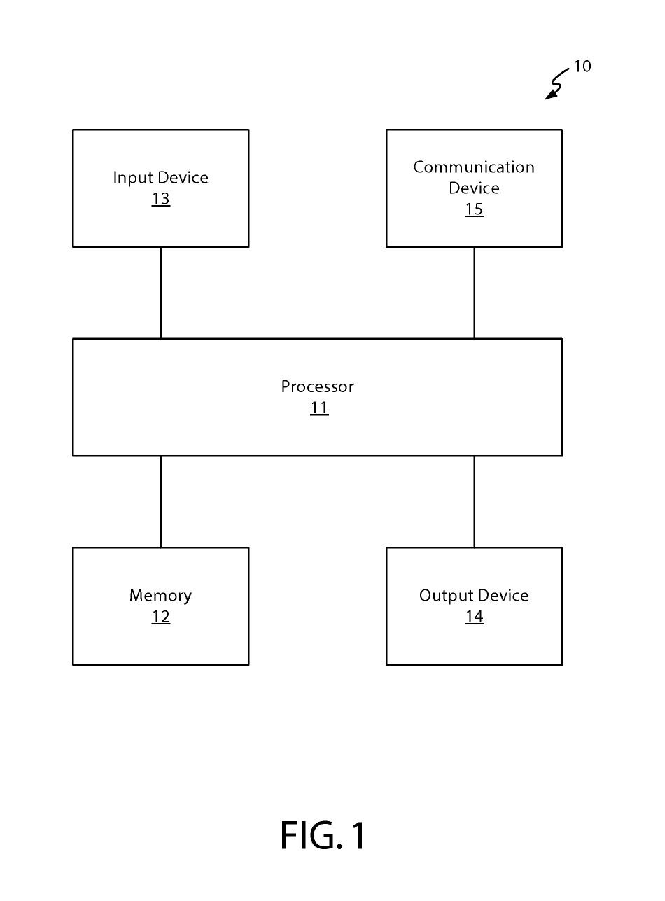

An embodiment of the invention and its potential advantages are understood by referring to FIGS. 1 through 12 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a laptop computer, a tablet computer, a mobile phone, a kiosk, an electronic table, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries. For example, the apparatus may be, at least part of, a non-carryable apparatus, such as a large screen television, an electronic table, a kiosk, an automobile, and/or the like.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with third-generation (3G) wireless communication protocols, fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

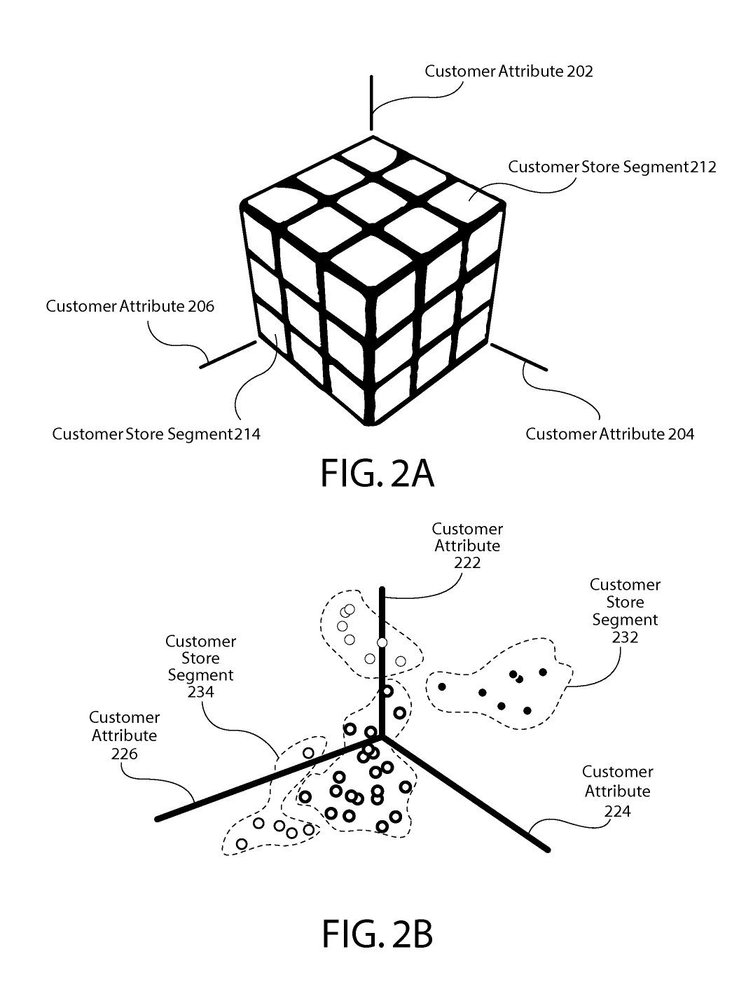

FIGS. 2A-2B are diagrams illustrating a set of customer store segments according to at least one example embodiment. The examples of FIGS. 2A-2B are merely examples and do not limit the scope of the claims. For example, axis count may vary, customer store segment count may vary, clusters may vary, and/or the like.

In many circumstances, merchants, purchasers, and/or similar individuals or entities may desire to buy merchandise, stock inventory, purchase goods, and/or the like. In such circumstances, the merchants may desire to utilize actionable information such that the actions of the merchant reflect potential consumer demand, are based on historical information, are justifiable in terms of business forecasts, and/or the like. As such, it may be desirable to improve merchants' and/or purchasers' access to actionable information. Such actionable information may be derived from synthesized customer and market data, historical sales and other transaction data, future planning objectives, and/or the like, such that the process of buying is well aligned with localized customer preferences, financial objectives, merchandise assortment goals, and/or the like. In this manner, such access to actionable information during the buying process may facilitate improvement in customer satisfaction, customer experiences, etc., and may result in improved business outcomes, increased revenue generation, decreased overstocked inventory, and/or the like.

In many circumstances, a merchant may consider one or more factors when evaluating a potential purchase of a product, of merchandise, and/or the like. For example, the merchant may desire to be informed regarding which stores or channels the product is most likely to sell. In another example, the merchant may wish to know how well the product will likely sell in each segment of the merchant's business. In this manner, the merchant may desire to know whether projected sales of the product justify a working capital investment into inventory, distribution, marketing, and/or the like. Additionally, the merchant may desire to know which stores, channels, etc. should be considered when purchasing the product.

For example, in many circumstances, a merchant may base many purchase decisions on total unit sales volume, sale volume by category, and/or the like. In such an example, category unit sales volume may be used to estimate potential sales performance of a particular product of a particular category. For example, if a store has historically sold twice as many products as an average store over a predetermined duration of time, such as a quarter, a year, a season, etc., that store may be likely to continue selling twice as many products as the average store in the future. In such an example, this store-specific sales trend may not vary by price point, material, brand, and/or the like. Such approximations that are based, at least in part, on category sales may be refined by way of utilizing historical sales of one or more specific products sold by a store or a group of stores over a predetermined duration of time. The historical sales of the specific product may be utilized as a basis for forecasting the sales of a new product, a similar product, and/or the like. In this manner, the approximation may be based, at least in part, on the availability of historical sales data associated with similar products, the skill and/or judgment of the merchant making the selection, and/or the like. As such, it may be desirable to provide a merchant with an easy and intuitive manner in which to forecast future sales, direct purchasing decisions, and/or the like.

In many circumstances, a merchant may desire to purchase products for a particular store, a grouping of stores, a particular retail channel, and/or the like. In such circumstances, the merchant may desire to target such stores, may desire to purchase particular products for a particular grouping of stores and different products for a different grouping of stores, and/or the like. As such, a particular purchasing decision may be based, at least in part, on identification of a particular set of stores. In at least one example embodiment, a set of stores is identified. The set of stores may comprise information indicative of a plurality of stores. The store may be a selling location, a fulfillment location, etc. that may exist in a particular retail channel, a plurality of retail channels, and/or the like. For example, the store may be a selling location that is associated with a physical store, a mail-order store, a telephone-order store, an internet store, and/or the like. In another example, the store may be a fulfillment location that is associated with a distribution location, an order fulfillment center, a warehouse location, a sales kiosk, an order pick-up location, and/or the like. In at least one example embodiment, the identification of the set of stores comprises receipt of information indicative of the set of stores from at least one of user input, a memory, a database, or a separate apparatus. For example, the set of stores may be configured by a user of the apparatus, manually inputted, selected from a list of available stores, and/or the like. In another example, the set of stores may be selected from a database by way of a directive that governs selection of the set of stores from the database.

In such circumstances, the merchant may desire to characterize a particular store in order to facilitate customization of purchasing decisions on a store by store basis, based on a group by group basis, and/or the like. For example, circumstances associated with a store and a different store may be such that the store and the different store warrant individualized considerations regarding purchasing decisions, inventory management, and/or the like. In at least one example embodiment, each store of a set of stores comprises a set of store attributes. In such an example embodiment, the store attribute may indicate at least one characteristic of a store associated with the store attribute. For example, the store attribute may indicate a location of the associated store, a market region associated with the store, a size of the associated store, a revenue of the associated store, an average transaction amount associated with the store, and/or the like. In such an example, a set of stores may be identified by way of selection of the set of stores from a database that comprises information indicative of a plurality of stores. In such an example, the set of stores may be selected by way of a directive that identifies stores associated with one or more predetermined store attributes, user configurable store attributes, user definable store attributes, and/or the like. In at least one example embodiment, a plurality of stores of a set of stores have a similar value for a particular store attribute. For example, a certain value store attribute may be equal or similar across a number of stores.

In many circumstances, a merchant may desire to cater to a particular group of customers, may desire to base purchasing decisions on customers of the merchant, and/or the like. As such, the merchant may desire to utilize information that characterizes customers of the merchant. In this manner, it may be desirable to describe a set of customers by way of demographic and/or lifestyle-related attributes that are easy and intuitive to understand for the merchant, a purchaser, a buyer, and/or the like. In at least one example embodiment, a set of customer attributes is identified. A customer attribute may indicate a characteristic of a customer, a property of a customer, and/or the like. Each customer attribute of the set of customer attributes may indicate an independent characteristic of a customer, a different characteristic of the customer, and/or the like. For example, a customer attribute comprised by the set of customer attributes may be indicative of a customer income range, a customer ethnicity, a customer age, a customer age range, a customer marital status, a customer dependent status, a customer gender, a customer interest, a customer religion status, a customer housing status, and/or the like. In at least one example embodiment, the identification of the set of customer attributes comprises receipt of information indicative of the set of customer attributes from at least one of user input, a memory, a database, or a separate apparatus. For example, the set of customer attributes may be configured by a user of the apparatus, manually inputted, selected from a list of available customer attributes, and/or the like. In another example, the set of customer attributes may be selected from a database by way of a directive that governs selection of the set of customer attributes from the database. In at least one example embodiment, each customer attribute comprised by a set of customer attributes corresponds with personal data that is represented in customer historical data, a compilation of customer data, and/or the like. In this manner, identification of the set of customer attributes may comprise identification of one or more customer attributes from customer historical data.

In some circumstances, the set of customer attributes may identify a representative set of customer attributes, customer profiles, etc. that are associated with customers who make purchases at a particular store, at each store of a set of stores, and/or the like. In at least one example embodiment, each customer attribute comprised by the first set of customer attributes is attributable to a variety of customers. For example, each customer attribute may be attributable to a plurality of customers, a group of customers, and/or the like.

In many circumstances, it may be desirable to cluster two or more stores together. For example, two or more stores may share common store attributes. In another example, it may be desirable to limit resources utilized in analysis of a particular purchasing decision by way of grouping similar stores together into clusters. As such, stores that share one or more common store attributes, are associated with customers that share one or more common customer attributes, etc. may be clustered together for convenience, problem tractability, and/or the like. In at least one example embodiment, a set of stores is segmented into a set of customer store segments. In such an example embodiment, the segmentation may be based, at least in part, on correlation between each set of store attributes for each store of a set of stores and customer historical data that corresponds with a set of customer attributes. In such an example embodiment, the set of stores may be segmented into a set of customer store segments such that each customer store segment of the set of customer store segments consists of stores that have at least one homogenous customer attribute. For example, a set of stores may be segmented into a set of customer-centric store segments, wherein each customer-centric store segment comprises stores that are associated with similar customer profiles, customers with similar customer attributes, and/or the like. A customer store segment may identify a collection of stores that are characterized by a predominant set of customer attributes. For example, each customer-centric store segment may be labeled to indicate a set of customer attributes associated with a typical customer of the store. For example, each customer store segment of a set of customer store segments may be labeled to indicate one or more homogenous customer attribute of each store of the customer store segment.

In at least one example embodiment, customer historical data comprises information that indicates one or more values associated with one or more customer attributes associated with one or more customers. For example, the customer historical data may comprise customer loyalty program data, syndicated market data, syndicated shopper data, demographic data, lifestyle data, and/or the like. In some circumstances, a plurality of customers represented by the customer historical data may have a similar value for a particular customer attribute. As such, it may be desirable to group a number of customers into groups of similar customers based, at least in part, on similar and/or corresponding customer attributes. In this manner, the customer historical data may comprise one or more statistically accurate representation of a model customer. For example, one or more customers may be characterized by one or more representations of typical customer of a store, a frequent shopper of a set of stores, and/or the like. In many circumstances, customer historical data may be associated with historical sales information. For example, the customer historical data may comprise information indicative of prior purchases, customer purchase history, and/or the like. In at least one example embodiment, sales information that is comprised by the customer historical data that corresponds with one or more customer attributes of the set of customer attributes is identified. In such an example embodiment, the correlation between each set of store attributes for each store of the set of stores and customer historical data that corresponds with the set of customer attributes may be based, at least in part, on the sales information. The sales information may be indicative of specific customer transactions, anonymous customer transactions, customer group transactions, and/or the like. In such an example, a customer group may be a collective of members of a community that is presumed to shop at a store of the set of stores. For example, customers may be identified individually using sales transactions or other records maintained through a customer loyalty program. In another example, customers may remain anonymous, but identified collectively as members of communities that are known or assumed to shop in the vicinity of a given store location.

In some circumstances, segmentation of a set of stores into a set of customer store segments may be based, at least in part, on recognition of one or more clusters within a plurality of data points. For example, the segmentation of a set of stores into a set of customer store segments may comprise determination of an average value for each customer attribute of a set of customer attributes for each store of the set of stores based, at least in part, on customer historical data. The customer historical data may be associated with sales information of each store of the set of stores, and the determination of the average value for each customer attribute of the set of customer attributes may comprise identification of each customer attribute associated with the sales information.

In some circumstances, sales information may be incomplete, partial, generally applicable, and/or the like. For example, the sales information may fail to represent a particular customer attribute of a set of customer attributes. In such an example, it may be desirable to identify one or more additional attributes that may be associated with the particular customer attribute, indicative of the particular customer attribute, and/or the like. In at least one example embodiment, the determination of the average value for each customer attribute of the set of customer attributes comprises determination that a customer attribute of the set of customer attributes is unrepresented by sales information of each store of a set of stores, and identification of a secondary attribute that is represented by the sales information. In such an example embodiment, customer historical data may be identified to be a set of data that represents the customer attribute in relation to the secondary attribute, and the average value may be determined based, at least in part, on correlation between the secondary attribute and the customer attribute in the set of data. For example, a merchant may desire to reference a particular customer attribute, such as customer income, customer ethnicity, and/or the like, that fails to be represented by sales data, customer historical data, and/or the like. In such an example, the sales information may represent a customer attribute that is indicative of a location of a customer. In such an example, the secondary attribute may be location information associated with each store of the set of stores, and the set of data may comprise census information. Such census information may be indicative of the desired store attributes and/or customer attributes, and may comprise information indicative of regional ethnicity proportions, average incomes, and/or the like. In this manner, the average value may be determined based, at least in part, on correlation between the location-related secondary attribute and the customer attribute in the census information.

In some circumstances, it may be desirable to represent each store of a set of stores as an independent data point such that one or more customer store segments may be identifies by way of statistical analysis, visual analysis, mathematical grouping, and/or the like. In at least one example embodiment, each store of a set of stores is represented as a data point to form a plurality of data points such that each customer attribute of a set of customer attributes is an independent dimension of the data point. In such an example embodiment, a plurality of clusters of the plurality of data points may be identified. The identification of the plurality of clusters may be based, at least in part, on k-means clustering, centroid-based clustering, hierarchical clustering, linkage clustering, E-M clustering, distribution-based clustering, and/or the like. There are many existing manners in which to identify clusters within a plurality of data points, and many more manners are likely to be developed in the future. As such, the manner in which the clusters are identified does not necessarily limit the scope of the claims. In such an example embodiment, the set of customer store segments may be determined to comprise customer store segments that correspond with the plurality of clusters.

In some circumstances, it may be desirable to further segment a set of stores based, at least in part, on a common customer attribute and a common store attribute. In other words, it may be desirable to further segment each customer-centric store segment into sub-segments that consist of stores with similar store attribute profiles, similar customers, and/or the like. In at least one example embodiment, segmentation of a set of stores into a set of customer store segments comprises further segmentation such that each customer store segment of the set of customer store segments consists of stores that have at least one homogenous customer attribute and at least one homogenous store attribute.

FIG. 2A is a diagram illustrating a set of customer store segments according to at least one example embodiment. The example of FIG. 2A illustrates representation of a plurality of data points, and segmentation of a set of stores into a set of customer store segments based, at least in part, on clustering of the plurality of data points. As can be seen in the example of FIG. 2A, a three-dimensional segmented cube is illustrated in reference to three axis that indicate three customer attributes, customer attribute 202, 204, and 206. For example, the y-axis may be associated with customer attribute 202 that may indicate a customer age, the x-axis may be associated with customer attribute 204 that may indicate a household income, and the z-axis may be associated with customer attribute 206 that may indicate a percent Hispanic. As such, the set of customer attributes may be utilized to segment a set of stores into a set of customer store segments such that each customer store segment comprises one or more stores of the set of stores. Such a segmentation may be based, at least in part, on clustering of various combinations of the three customer attributes. For example, based, at least in part, on the position of customer store segment 212 with respect to the three axis, customer store segment 212 may be characterized by older, affluent, and low-percentage Hispanic customers. Similarly, customer store segment 214 may be characterized by younger, less-affluent, and higher-percentage Hispanic customers.

Although the example of FIG. 2A represents three customer attributes, and depicts a three by three grid of customer store segments, the number of customer attributes that may be analyzed may vary, and the resulting customer store segments are not necessarily bound by three dimensional space.

FIG. 2B is a diagram illustrating a set of customer store segments according to at least one example embodiment. The example of FIG. 2B illustrates representation of a plurality of data points, and segmentation of a set of stores into a set of customer store segments based, at least in part, on clustering of the plurality of data points. As can be seen in the example of FIG. 2B, a plurality of data point are plotted with respect to the three illustrated axis. For example, the y-axis may be associated with customer attribute 202 that may indicate a customer age, the x-axis may be associated with customer attribute 204 that may indicate a household income, and the z-axis may be associated with customer attribute 206 that may indicate a percent Hispanic. As such, the set of customer attributes may be utilized to segment a set of stores into a set of customer store segments that each comprise one or more stores of the set of stores. Such a segmentation may be based, at least in part, on clustering of various data points that represent combinations of the three customer attributes. For example, based, at least in part, on the position of customer store segment 232 with respect to the three axis, customer store segment 232 may be characterized by older, affluent, and low-percentage Hispanic customers. Similarly, customer store segment 234 may be characterized by younger, less-affluent, and higher-percentage Hispanic customers.

Although the example of FIG. 2B represents three customer attributes, and depicts the representation of the plurality of data points associated with the three customer attributes in relation to a three dimensional plot, the number of customer attributes that may be analyzed may vary, and the resulting customer store segments are not necessarily bound by three dimensional space.

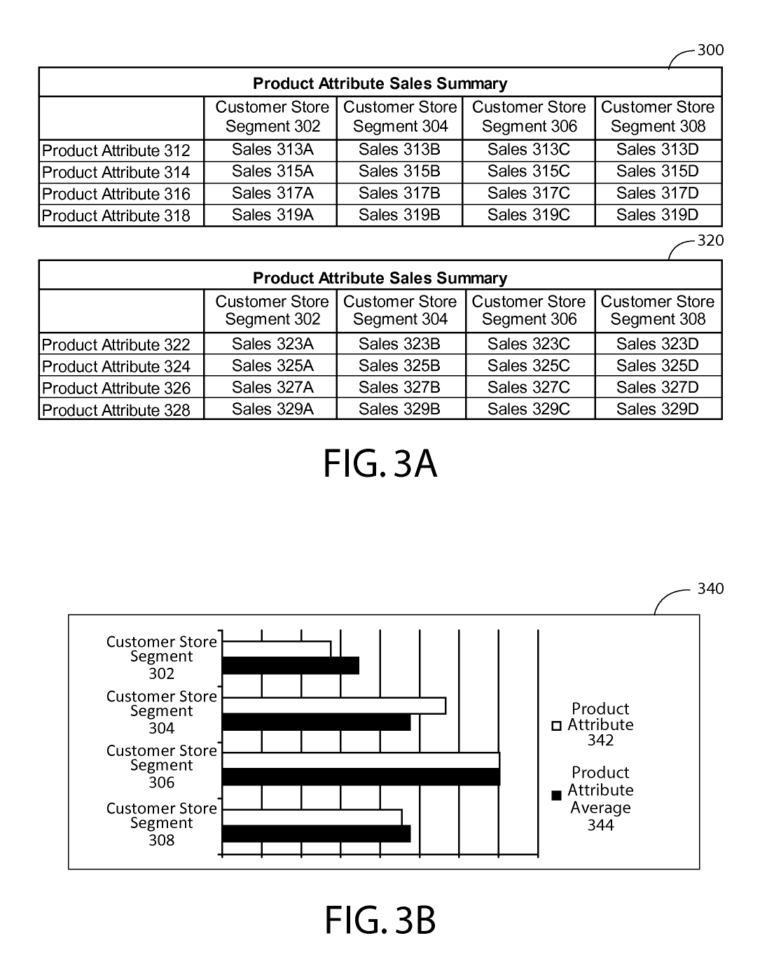

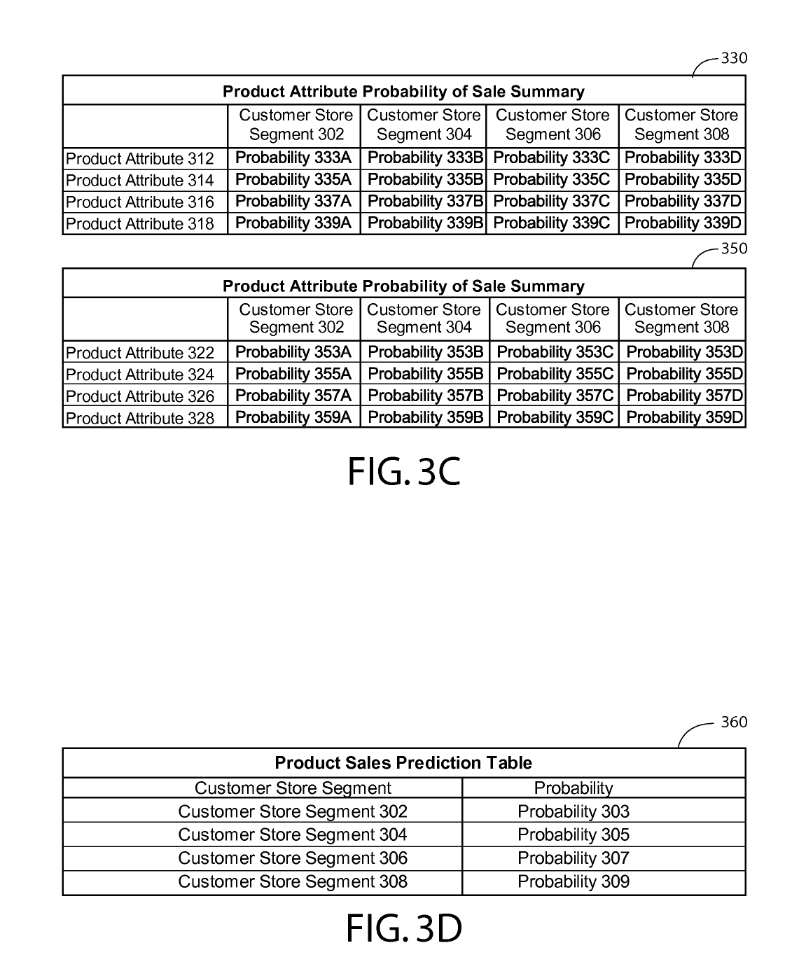

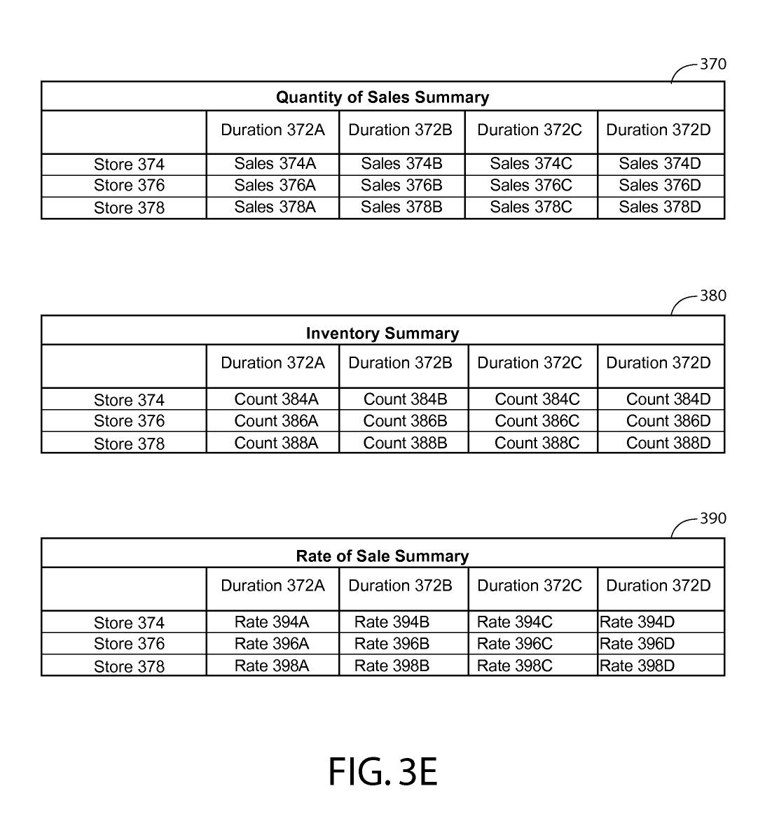

FIGS. 3A-3E are diagrams illustrating a set of product attribute sales summaries and information associated with the set of product attribute sales summaries according to at least one example embodiment. The examples of FIGS. 3A-3E are merely examples and do not limit the scope of the claims. For example, product attribute sales summary configuration and/or content may vary, customer store segment count may vary, product attribute count may vary, chart configuration and/or content may vary, product sales prediction table configuration and/or content may vary, and/or the like.

As described previously, in many circumstances, it may be desirable to facilitate a merchant in making informed business decisions, purchasing and assortment selections, and/or the like. As such, it may be desirable to facilitate selection of particular products by way of characteristics of the product, attributes of the product, and/or the like. In at least one example embodiment, a set of product attributes are identified. A product attribute may be an attribute of a product that classifies the product within a merchandise category. The product attribute may be an attribute that is descriptive of differences in styles of a products, descriptive of features of a product, indicative of a product characteristic that may influence the buying behavior of a customer, and/or the like.

In such circumstances, it may be desirable to reference sales data associated with a particular product attribute, a range of product attributes, a set of product attributes, and/or the like. For example, it may be desirable to base a future purchase decision on data that indicates historical sales performance of similar products, of products that are associated with similar product attributes, and/or the like. In at least one example embodiment, a set of product attribute sales summaries are generated. The set of product attribute sales summaries may comprise a product attribute sales summary for each customer store segment of a set of customer store segments, such that each product attribute sales summary of the set of product attribute sales summaries identifies a quantity of sales associated with each product attribute of the set of product attributes from each store within a customer store segment of the set of customer store segments. In such an example embodiment, the generation of the set of product attribute sales summaries may comprise identification of products that have a product attribute that corresponds with at least one of the product attributes of the set of product attributes. For example, the identification of the products may comprise receipt of information indicative of the products from at least one of user input, a memory, a database, or a separate apparatus. For example, the products may be selected by a user of the apparatus, manually inputted, selected from a list of available products, and/or the like. In another example, the products may be selected from a database by way of a directive that governs selection of the products from the database. For example, the products may be identified within the database based, at least in part, on at least one product attribute.

Each product attribute sales summary of the set of product attribute sales summaries may comprise rate of sale information, sales volume information, and/or the like. In such an example, identification of a quantity of sales associated with each product attribute of the set of product attributes may comprise grouping of products into a set of products that are associated with the product attribute, and determination of the quantity of sales associated with the set of products. For example, a set of products within a particular category of products may be grouped into a set of similar product types, each of which is identified by specific product attributes, a set of product attributes, and/or the like. In this manner, a list of sales transactions may be compiled for each product type, organized by customer-centric store segment, customer store segment, and/or the like. In some circumstances, it may be desirable to include non-discounted sales of products, and exclude discounted sales of products. For example, a full priced sale of a product may be indicative of a greater consumer desire for the product, and a discounted sell of the product may be indicative of a lesser consumer desire for the product. In at least one example embodiment, the generation of the set of product attribute sales summaries includes information indicative of non-discount priced sales. In at least one example embodiment, the generation of the set of product attribute sales summaries excludes information indicative of discount priced sales.

FIG. 3A is a diagram illustrating a set of product attribute sales summaries according to at least one example embodiment. The example of FIG. 3A depicts a set of product attribute sales summaries. In the example of FIG. 3A, the set of product attribute sales summaries comprises product attribute sales summary 300 and product attribute sales summary 320. As can be seen in product attribute sales summary 300, the quantity of sales data is attributable to the customer store segment that corresponds with the column of the quantity of sales data, and attributable to the set of product attributes that corresponds with the row of the quantity of sales data. As such, product attribute sales summary 300 correlates information indicative of quantity of sales data 313A-313D, 315A-315D, 317A-317D, and 319A-319D to sets of product attributes 312, 314, 316, and 318, respectively. Similarly, product attribute sales summary 300 correlates information indicative of quantity of sales data 313A-319A, 313B-319B, 313C-319C, and 313D-319D to customer store segments 302, 304, 306, and 308, respectively. In this manner, quantity of sales data 313A may indicate a quantity of sales of products associated with set of product attributes 312 within customer store segment 302. Similarly, quantity of sales data 317D may indicate a quantity of sales of products associated with set of product attributes 316 within customer store segment 308. In the example of FIG. 3A, customer store segments 302, 304, 306, and 308 may correspond with one or more of the customer store segments depicted in the example of FIG. 2A and/or FIG. 2B. As such, customer store segments 302, 304, 306, and 308 may have been identified based, at least in part, on clustering of data points that represent various combinations of customer attributes.

In many circumstances, it may be desirable to quantify the merit of a particular selection of customer store segments, customer attributes, product attributes, and/or the like. For example, a particular selection of and correlation of customer attributes and product attributes, groups on a customer store segment basis, may indicate a particularly interesting purchasing trend, may fail to indicate a particular purchasing bias, and/or the like. In this manner, it may be desirable to quantify the usefulness of the resulting product attribute sales summaries in order to determine whether additional analysis is warranted, whether additional refinement may be beneficial, and/or the like. In at least one example embodiment, a distinctiveness rating is determined for a product attribute sales summary for each customer store segment of a set of customer store segments. The distinctiveness rating may indicate a variation of sales performance across each product attribute sales summary. The determination of the distinctiveness rating may be based, at least in part, on an information gain for the product attributes of the set of product attributes. For example, a product attribute sales summary that provides for a high level of information gain may be more distinctive than another product attribute sales summary that allows for a low level of information gain. As such, the distinctiveness rating may be based on the information gain associated with the selected product attributes in inferring sales performance of product types on a per customer store segment basis.

FIG. 3B is a diagram illustrating a chart associated with a set of product attribute sales summaries according to at least one example embodiment. The example of FIG. 3B depicts chart 340. In the example of FIG. 3B, chart 340 represents one or more product attribute sales summaries. For example, chart 340 may represent product attribute sales summary 300, product attribute sales summary 320, and/or the like. As can be seen, chart 340 represents sales information associated with a particular set of product attributes for each customer store segment. In the example of FIG. 3B, chart 340 represents quantity of sales data that is attributable to set of product attributes 342. As can be seen, the quality of sales data is charted as white bars along the horizontal axis of chart 340, such that a longer bar indicates a higher quantity of sales, and a shorter bar indicates a lower quantity of sales. In order to facilitate determination of a distinctiveness rating associated with a particular set of product attribute sales summaries, it may be desirable to provide baseline information with which to compare the quantity of sales data to. As such, in the example of FIG. 3B, chart 340 represents average quantity of sales data by way of black horizontal bars, as indicated by product attribute average 344. Such average quantity of sales data may be associated with an average quantity of sales across all stores within a set of stores, within all customer store segments of a set of customer store segments, attributable to purchases made by all customers, and/or the like. In this manner, a distinctiveness rating may be determined by way of a comparison between the product attribute sales summary quantity of sales data and the average quantity of sales data.

In some circumstances, it may be desirable to iteratively refine various facets of the analysis in order to facilitate exploration of a variety of choices and combinations of customer attributes, product attributes, and/or the like. Such iterative refinement may help yield useful insights into selling patterns, customer purchase predictions, and/or the like. As such, it may be desirable to identify another set of customer attributes, another set of product attributes, and/or the like.

For example, a first set of customer attributes may be identified, a set of stores may be segmented into a first set of customer store segments, a first set of product attribute sales summaries may be generated, and a first distinctiveness rating determined. In such an example, it may be desirable to analyze another combination of customer attributes, product attributes, customer store segments, and/or the like. As such, a second set of customer attributes may be identified. In such an example, the set of stores may be segmented into a second set of customer store segments based, at least in part, on correlation between each store of the set of stores and customer historical data that corresponds with the second set of customer attributes. The set of stores may be segmented into the second set of customer store segments such that each customer store segment of the second set of customer store segments consists of stores that have at least one homogenous customer attribute. In such an example, a second set of product attribute sales summaries may be generated. The second set of product attribute sales summaries may comprise a product attribute sales summary for each customer store segment of the second set of customer store segments, such that each product attribute sales summary of the second set of product attribute sales summaries identifies a quantity of sales associated with each product attribute of the first set of product attributes from each store within a customer store segment of the second set of customer store segments. In order to facilitate comparison between the first set of product attribute sales summaries and the second set of product attribute sales summaries, it may be desirable to determine a distinctiveness rating for the second set of product attribute sales summaries. In such an example, a second distinctiveness rating may be determined for the product attribute sales summary for each customer store segment of the second set of customer store segments.

In another example, a first set of customer attributes may be identified, a set of stores may be segmented into a first set of customer store segments, a first set of product attribute sales summaries may be generated, and a first distinctiveness rating determined. In such an example, it may be desirable to analyze another combination of customer attributes, product attributes, customer store segments, and/or the like. As such, a second set of product attributes may be identified. In such an example, a second set of product attribute sales summaries may be generated. The second set of product attribute sales summaries may comprise a product attribute sales summary for each customer store segment of the first set of customer store segments, such that each product attribute sales summary of the second set of product attribute sales summaries identifies a quantity of sales associated with each product attribute of the second set of product attributes from each store within a customer store segment of the first set of customer store segments. In order to facilitate comparison between the first set of product attribute sales summaries and the second set of product attribute sales summaries, it may be desirable to determine a distinctiveness rating for the second set of product attribute sales summaries. In such an example, a second distinctiveness rating may be determined for the product attribute sales summary for each customer store segment of the first set of customer store segments.

As can be seen in the example of FIG. 3A, the set of product attribute sales summaries comprises product attribute sales summary 300 and product attribute sales summary 320. In the example of FIG. 3A, product attribute sales summary 300 and product attribute sales summary 320 are associated with customer stores segments 302, 304, 306, and 308. However, as can be seen, product attribute sales summary 300 is associated with sets of product attributes 312, 314, 316, and 318, and product attribute sales summary 320 is associated with sets of product attributes 322, 324, 326, and 328. As can be seen in product attribute sales summary 320, the quantity of sales data is attributable to the customer store segment that corresponds with the column of the quantity of sales data, and attributable to the set of product attributes that corresponds with the row of the quantity of sales data. As such, product attribute sales summary 320 correlates information indicative of quantity of sales data 323A-323D, 325A-325D, 327A-327D, and 329A-329D to sets of product attributes 322, 324, 326, and 328, respectively. Similarly, product attribute sales summary 320 correlates information indicative of quantity of sales data 323A, 325A, 327A, and 329A to customer store segment 302, quantity of sales data 323B, 325B, 327B, and 329B to customer store segment 304, quantity of sales data 323C, 325C, 327C, and 329C to customer store segment 306, and quantity of sales data 323D, 325D, 327D, and 329D to customer store segment 308. In this manner, quantity of sales data 323A may indicate a quantity of sales of products associated with set of product attributes 322 within customer store segment 302. Similarly, quantity of sales data 327D may indicate a quantity of sales of products associated with set of product attributes 326 within customer store segment 308.

In some circumstances, it may be desirable to identify another set of customer attributes and another set of product attributes. For example, a first set of customer attributes may be identified, a set of stores may be segmented into a first set of customer store segments, a first set of product attribute sales summaries may be generated, and a first distinctiveness rating determined. In such an example, it may be desirable to analyze another combination of customer attributes, product attributes, customer store segments, and/or the like. As such, a second set of customer attributes may be identified. In such an example, the set of stores may be segmented into a second set of customer store segments based, at least in part, on correlation between each store of the set of stores and customer historical data that corresponds with the second set of customer attributes. The set of stores may be segmented into the second set of customer store segments such that each customer store segment of the second set of customer store segments consists of stores that have at least one homogenous customer attribute. In such an example, a second set of product attributes may be identified, and a second set of product attribute sales summaries may be generated. The second set of product attribute sales summaries may comprise a product attribute sales summary for each customer store segment of the second set of customer store segments, such that each product attribute sales summary of the second set of product attribute sales summaries identifies a quantity of sales associated with each product attribute of the second set of product attributes from each store within a customer store segment of the second set of customer store segments. In order to facilitate comparison between the first set of product attribute sales summaries and the second set of product attribute sales summaries, it may be desirable to determine a distinctiveness rating for the second set of product attribute sales summaries. In such an example, a second distinctiveness rating may be determined for the product attribute sales summary for each customer store segment of the second set of customer store segments.

Subsequent to identification of useful selling patterns by way of analyzing one or more sets of product attribute sales summaries, it may be desirable to determine a sales model that may facilitate a business decision, a product purchase, an inventory allotment, and/or the like. In at least one example embodiment, a customer store segment sales model is determined. The customer store segment sales model may be based, at least in part, on a set of customer store segments, a set of product attribute sales summaries, a distinctiveness rating, and/or the like. In some circumstances, analysis may have been conducted by way of more than one set of customer attributes, more than one set of product attributes, more than one set of customer store segments, more than one set of product attribute sales summaries, more than one distinctiveness rating, and/or the like. As such, the determination of the customer store segment sales model may be based, at least in part, on a plurality of sets of customer attributes, sets of product attributes, sets of customer store segments, sets of product attribute sales summaries, distinctiveness ratings, and/or the like. In some circumstances, more than one set of product attribute sales summaries may be generated. In such circumstances, a distinctiveness rating may be determined for each set of product attribute sales summaries. In order to facilitate determination of an optimal customer store segment sales model, it may be desirable to determine the customer store segment sales model based, at least in part, on the most distinctive set of product attribute sales summaries. For example, a first set of product attribute sales summaries associated with a first distinctiveness rating and a second set of product attribute sales summaries associated with a second distinctiveness rating may be determined. In such an example, it may be desirable to compare the first distinctiveness rating and the second distinctiveness rating, and to determine the customer store segment sales model based, at least in part, on the greater of the two product attribute sales summaries. In such an example, it may be determined that the first distinctiveness rating is greater than the second distinctiveness rating. As such, in such an example, the customer store segment sales model may be determined to comprise a set of customer store segments associated with the first distinctiveness rating based, at least in part, on the determination that the first distinctiveness rating is greater than the second distinctiveness rating. In this manner, if a variation of sales performance across customer store segments shown in a set of product attribute sales summaries is determined to be sufficiently distinctive, the set of product attribute sales summaries may be utilized in order to facilitate prediction of future sales performance of products associated with the respective set of product attributes.

In some circumstances, it may be desirable to be aware of how well products that are associated with a particular product attribute sell relative to other products that are associated with the same product attribute. For example, it may be desirable to compare the sales performance of a particular type of shoe against the sales performance of a different type of shoe, against shoes in general, and/or the like. As such, it may be desirable to convert the quantity of sales data comprised by a product attribute sales summary into a probability of sale attributable to a desired combination of product attributes.

FIG. 3C is a diagram illustrating a set of product attribute probability of sale summaries according to at least one example embodiment. The example of FIG. 3C depicts a set of product attribute probability of sale summaries that correspond with the set of product attribute sales summaries of FIG. 3A. In the example of FIG. 3C, the set of product attribute probability of sale summaries comprises product attribute probability of sale summary 330 and product attribute probability of sale summary 350, which correspond with product attribute sales summary 300 and product attribute sales summary 320, respectively. As can be seen in product attribute probability of sale summary 330, the probability of sale data is attributable to the customer store segment that corresponds with the column of the probability of sale data, and attributable to the set of product attributes that corresponds with the row of the probability of sale data. As such, product attribute probability of sale summary 330 correlates information indicative of probability of sale data 333A-333D, 335A-335D, 337A-337D, and 339A-339D to sets of product attributes 312, 314, 316, and 318, respectively. Similarly, product attribute probability of sale summary 330 correlates information indicative of probability of sale data 333A, 335A, 337A, and 339A to customer store segment 302, 333B, 335B, 337B, and 339B to customer store segment 304, 333C, 335C, 337C, and 339C to customer store segment 306, and 333D, 335D, 337D, and 339D to customer store segment 308. In this manner, probability of sales data 333A may indicate a probability of sale of products associated with set of product attributes 312 within customer store segment 302. Similarly, probability of sale data 337D may indicate a quantity of sales of products associated with set of product attributes 316 within customer store segment 308.

Similarly, as can be seen in product attribute probability of sale summary 350, the probability of sale data is attributable to the customer store segment that corresponds with the column of the probability of sale data, and attributable to the set of product attributes that corresponds with the row of the probability of sale data. As such, product attribute probability of sale summary 350 correlates information indicative of probability of sale data 353A-353D, 355A-355D, 357A-357D, and 359A-359D to sets of product attributes 322, 324, 326, and 328, respectively. Similarly, product attribute probability of sale summary 350 correlates information indicative of probability of sale data 353A, 355A, 357A, and 359A to customer store segment 302, 353B, 355B, 357B, and 359B to customer store segment 304, 353C, 355C, 357C, and 359C to customer store segment 306, and 353D, 355D, 357D, and 359D to customer store segment 308. In this manner, probability of sales data 353A may indicate a probability of sale of products associated with set of product attributes 322 within customer store segment 302. Similarly, probability of sale data 357D may indicate a quantity of sales of products associated with set of product attributes 326 within customer store segment 308.

In the example of FIG. 3C, customer store segments 302, 304, 306, and 308 may correspond with one or more of the customer store segments depicted in the example of FIG. 2A and/or FIG. 2B. As such, customer store segments 302, 304, 306, and 308 may have been identified based, at least in part, on clustering of data points that represent various combinations of customer attributes.

In some circumstances, it may be desirable to predict future sales performance by way of analysis of historical sales information. In at least one example embodiment, a customer store segment sales model comprises product rate of sale information and product sales volume information. For example, the rate of sale information may identify a number of sales associated with a set of product attributes in relation to a predetermined period of time, and the product sales volume information may identify a number of sales associated with a set of product attributes within a predetermined period of time. For example, the product rate of sale information may identify a number of sales per week, and the product sales volume information may identify a total number of sales attributable to products that are associated with the set of product attributes. In at least one example embodiment, the determination of the customer store segment sales model comprises normalization of product attribute sales summary sales volume information to generate the product sales volume information of the customer store segment sales model. The normalization of the product attribute sales summary sales volume may comprise normalization of the product attribute sales summary sales volume with respect to an aggregate sales volume associated with the customer store segment that is associated with the product sales attribute summary.

For example, once the analysis has yielded useful selling patterns, various metrics may be used as predictors of future sales performance. Such metrics may be associated with relative unit sales volume, rate of sale, and/or the like. In such an example, the metrics may be attributed to products associated with a particular set of product attributes using statistical modeling techniques, such as 1R, Bayes Rule, or any other statistical modeling technique that yields an acceptable error rate. The choice of a particular statistical modeling technique may be validated and/or compared to other candidate statistical modeling techniques by using a subset of a set of product attribute sales summaries to generate a customer store segment sales model, and reservation of at least a portion of the set of product attribute sales summaries for statistical testing purposes. In at least one example embodiment, a customer store segment sales model is a data structure that correlates data between dimensions of the data structure. For example, the customer store segment sales model may correlate each customer store segment of a set of customer store segments with product rate of sale information, product sales volume information, and/or the like. In another example, the customer store segment sales model may correlate each customer store segment of a set of customer store segments with a suggested product purchase volume that indicates a suggested number of products to purchase for each store of each customer store segment of the set of customer store segments.

In many circumstances, once a customer segment sales model has been determined, it may be desirable to utilize and/or reference the customer segment sales model for purposes relating to inventory management, purchasing recommendations, and/or the like. For example, a merchant may decide to purchase a particular product, and plan to sell the product in the next quarter. In such an example, the merchant may desire to know in which of the merchant's stores the product is likely to sell well, in which of the merchant's stores like product is likely to sell poorly, and/or the like. For example, a merchant may desire to know, given the existence of a sale of a particular product, the probability that the sale of the product occurred in a store in a specific customer store segment, occurred in a customer store segment of a set of customer store segments, and/or the like.

FIG. 3D is a diagram illustrating a product sales prediction table according to at least one example embodiment. The example of FIG. 3D depicts product sales prediction table 360. Product sales prediction table 360 may be based, at least in part, on a set of product attribute sales summaries, a customer store segment sales model, and/or the like. In the example of FIG. 3D, product sales prediction table 360 depicts a set of probabilities of sales associated with a particular set of customer store segments. As can be seen, customer store segment 302 is associated with probability of sale 303, customer store segment 304 is associated with probability of sale 305, customer store segment 306 is associated with probability of sale 307, and customer store segment 308 is associated with probability of sale 309. As such, given a sale of a product that is associated with the set of product attributes that is associated with product sales prediction table 360, product sales prediction table 360 indicates a probability that the specific sale took place at each of customer store segments 302, 304, 306, and 308.

As discussed previously, it may be desirable to predict future sales performance by way of analysis of historical sales information. Such historical sales information may comprise quantity of sales over a predetermined duration, inventory status of a particular product type, rate of sale information over a predetermined duration, and/or the like. As such, trends in the historical sales information may be identified by way of analysis and/or correlation of such information.

FIG. 3E is a diagram illustrating a quantity of sales summary, an inventory summary, and a rate of sale summary according to at least one example embodiment. The example of FIG. 3E depicts a set of historical sales information summaries. In the example of FIG. 3E, the set of historical sales information summaries comprises quantity of sales summary 370, inventory summary 380, and rate of sale summary 390. As can be seen in quantity of sales summary 370, the quantity of sales data is a quantity of sales attributable to a specific store, a specific customer store segment, and/or the like, over a predetermined duration. As such, quantity of sales summary 370 correlates information indicative of quantity of sales data 374A-374D, 376A-376D, and 378A-378D for a particular product type to stores 374, 376, and 378, respectively. In this manner, quantity of sales summary 370 indicates a quantity of sales attributable to the specific store, the specific customer store segment, and/or the like, over a number of successive durations. For example, durations 372A-372D may each be a week duration, such that quantity of sales data for four successive weeks is comprised by quantity of sales summary 370.

In some circumstances, quantity of sales data may be affected by factors other than a consumer's willingness to purchase a particular produce type. For example, a specific store may have stocked an insufficient number of the product type, the store may have failed to reorder such inventory, the store may have run out of stock on the particular product type, and/or the like. As such, it may be desirable to consider inventory information specific to inventory status of products of the particular product type. In this manner, a low quantity of sales over a specific duration at a particular store may correspond with a low or out of stock inventory over the same duration and at the same store.

As can be seen in inventory summary 380, the inventory data is a count of inventory that is attributable to a specific store, a specific customer store segment, and/or the like, over a predetermined duration. As such, inventory summary 380 correlates information indicative of inventory data 384A-384D, 386A-386D, and 388A-388D for a particular product type to stores 374, 376, and 378, respectively. In this manner, inventory summary 380 indicates a quantity of sales attributable to the specific store, the specific customer store segment, and/or the like, over a number of successive durations. For example, durations 372A-372D may each be a week duration, such that inventory data for four successive weeks is comprised by inventory summary 380.

As discussed previously, in some circumstances, it may be desirable to consider rate of sales data in conjunction with quantity of sales data. For example, two stores and/or customer store segments may produce a similar quantity of sales, but one of the stores and/or customer store segments may have produced the quantity of sales over a much shorter duration, sporadically as inventory was replenished, and/or the like. Such a comparison allows for inferences regarding the popularity and future sales potential of a particular product type, and may aid in future purchasing decisions, stock management, and/or the like.

As can be seen in rate of sale summary 390, the rate of sale data is a rate of sale that is attributable to a specific store, a specific customer store segment, and/or the like, over a predetermined duration. As such, rate of sale summary 390 correlates information indicative of rate of sale data 394A-394D, 396A-396D, and 398A-398D for a particular product type to stores 374, 376, and 378, respectively. In this manner, rate of sale summary 390 indicates a rate of sale attributable to the specific store, the specific customer store segment, and/or the like, over a number of successive durations. For example, durations 372A-372D may each be a week duration, such that rate of sale data for four successive weeks is comprised by rate of sale summary 390.

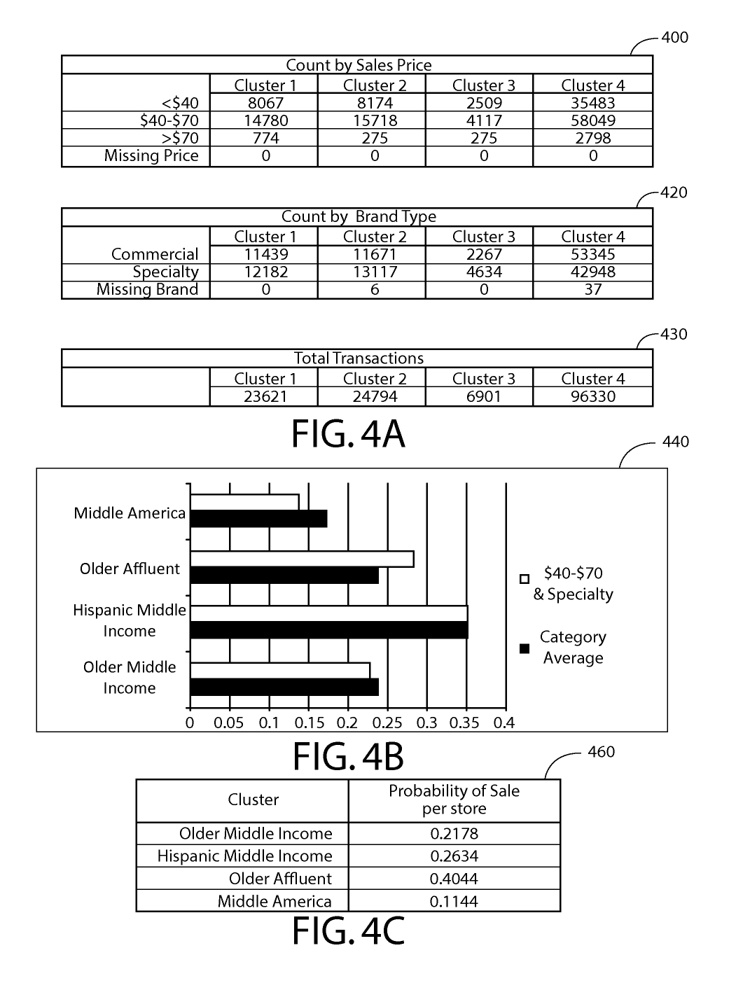

FIGS. 4A-4C are diagrams illustrating a set of product attribute sales summaries and information associated with the set of product attribute sales summaries according to at least one example embodiment. The examples of FIGS. 4A-4C are merely examples and do not limit the scope of the claims. For example, product attribute sales summary configuration and/or content may vary, customer store segment count may vary, product attribute count may vary, graph configuration and/or content may vary, product sales prediction table configuration and/or content may vary, and/or the like.

For example, a merchant may sell various products by way of a chain of physical store locations. In such an example, the merchant desire to sell men's athletic shoes. In such an example, a set of three customer attributes may characterize male customers: annual household income, percentage Hispanic, and age. In such an example, the merchant may maintain loyalty account information that provides a household income, an age bracket, and a residential zip code for each customer that is enrolled in the loyalty account program. As such, two of the three customer attributes may be directly identified by way of the loyalty account information. The third customer attribute, the percentage Hispanic, may be determined based, at least in part, on the residential zip code. For example, census data that indicates an average demographic for a particular zip code may be identified by way of the residential zip code that is indicated in the loyalty account information. As such, in such an example, the set of customer attributes may comprise an annual household income, a percentage Hispanic, and an age. The annual household income may indicate a household income of less than $50,000, $50,000-$80,000, or greater than $80,000. The percentage Hispanic may indicate a percentage that is less than 5%, 5%-15%, or greater than 15%. The age may indicate age ranges of 18-39, 30-50, and over 50. In such an example, a set of product attributes associated with such men's athletic shoes may be identified. For example, the set of product attributes may comprise a price point and a band type. The price point may indicate that a pair of men's athletic shoes are priced under $40, $40-$70, or greater than $70. The brand type may indicate that the pair of men's athletic shoes are of the commercial type or the specialty type. As such, four customer store segments may be identified—cluster 1, which is characterized by “Older Middle Income” and comprises 41 stores, cluster 2, which is characterized by “Hispanic Middle Income” and comprises 29 stores, cluster 3, which is characterized by “Older Affluent” and comprises 12 stores, and cluster 4, which is characterized by “Middle America” and comprises 230 stores.

FIG. 4A is a diagram illustrating a set of product attribute sales summaries according to at least one example embodiment. As can be seen, FIG. 4A depicts product attribute sales summary 400 and product attribute sales summary 420. Each of product attribute sales summary 400 and product attribute sales summary 420 correlate clusters 1, 2, 3, and 4, which are customer store segments, and various product attributes, to the indicated quantity of sales data. For example, product attribute sales summary 400 indicates that 15718 men's athletic shoes in the $40-$70 price range were sold in cluster 2, and that 774 men's athletic shoes in the greater than $70 price range were sold in cluster 1. In another example, product attribute sales summary 420 indicates that 11439 men's athletic shoes of the commercial type were sold in cluster 1, and that 4634 men's athletic shoes of the specialty type were sold in cluster 3. As can be seen, the example of FIG. 4A also depicts table 430, which indicates a total quantity of sales of men's athletic shoes across all product attributes and purchased by all customers within an indicated customer store segment. For example, table 430 indicates that 23621 pairs of men's athletic shoes were sold in cluster 1, and 96330 men's athletic shoes were sold in cluster 4.

FIG. 4B is a diagram illustrating a chart associated with a set of product attribute sales summaries according to at least one example embodiment. The example of FIG. 4B corresponds with the product attribute sales summaries depicted in the example of FIG. 4A. As can be seen, chart 440 depicts sales of men's athletic shoes that are in the $40-$70 price range and of the specialty type with respect to a “Middle America” customer store segment, an “Older Affluent” customer store segment, a “Hispanic Middle Income” customer store segment, and an “Older Middle Income” customer store segment. The usefulness of the results may be evaluated visually by charting the results for specific combinations of product attributes with respect to the respective customer store segment, as shown in chart 440. As can be seen, chart 440 depicts the probabilities of sale for each customer store segment for men's athletic shoes that are associated with the indicated product attributes. As can be seen, the resulting probabilities are similar to the probabilities indicated by the category average. As such, a distinctiveness rating associated with the product attribute sales summary associated with chart 440 may be lower than another product attribute sales summary that yields more interesting and/or useful results.

Analysis of chart 440 supports the forming of various inferences. For example, quantity of sales for the indicated men's athletic shoes do not deviate significantly from the category average quantity of sales in the middle income customer store segments, “Hispanic Middle Income” and “Older Middle Income”. Additionally, although the quantity of sales per store for all men's athletic shoes on average is roughly equal for stores in the “Older Affluent” and “Older Middle Income” customer store segments, men's athletic shoes of the specific type indicated, specialty brands in the $40-$70 price bracket, sell significantly better in the “Older Affluent” customer store segment. As such, it may be desirable to allot additional inventory of men's athletic shoes associated with the indicated product attributes to stores within the “Older Affluent” customer store segment. Additionally, chart 440 indicates that the sales of the specific men's athletic shoe type at stores in the “Middle America” customer store segment are fewer than the average category performance might indicate. As such, it may be desirable to apportion fewer less inventory of men's athletic shoes associated with the indicated product attributes to stores within the “Middle America” customer store segment than may be indicated by average men's athletic shoe performance might indicate.

FIG. 4C is a diagram illustrating a product sales prediction table according to at least one example embodiment. The example of FIG. 4C depicts product sales prediction table 460. Product sales prediction table 460 may be based, at least in part, on a set of product attribute sales summaries, a customer store segment sales model, and/or the like. In the example of FIG. 4C, product sales prediction table 360 depicts a set of probabilities of sales associated with a particular set of customer store segments. As can be seen, the “Older Middle Income” customer store segment is associated with a 0.2178 probability of sale, the “Hispanic Middle Income” customer store segment is associated with a 0.2634 probability of sale, the “Older Affluent” customer store segment is associated with a 0.4044 probability of sale, and the “Middle America” customer store segment is associated with a 0.1144 probability of sale. As such, given a sale of a pair of men's athletic shoes, product sales prediction table 360 indicates a probability that the specific sale took place at each of the indicated customer store segments. In this manner, a merchant may utilize such information in determining how to allot the merchant's inventory of men's athletic shoes among the merchant's stores, between the various customer stores segments, and/or the like.

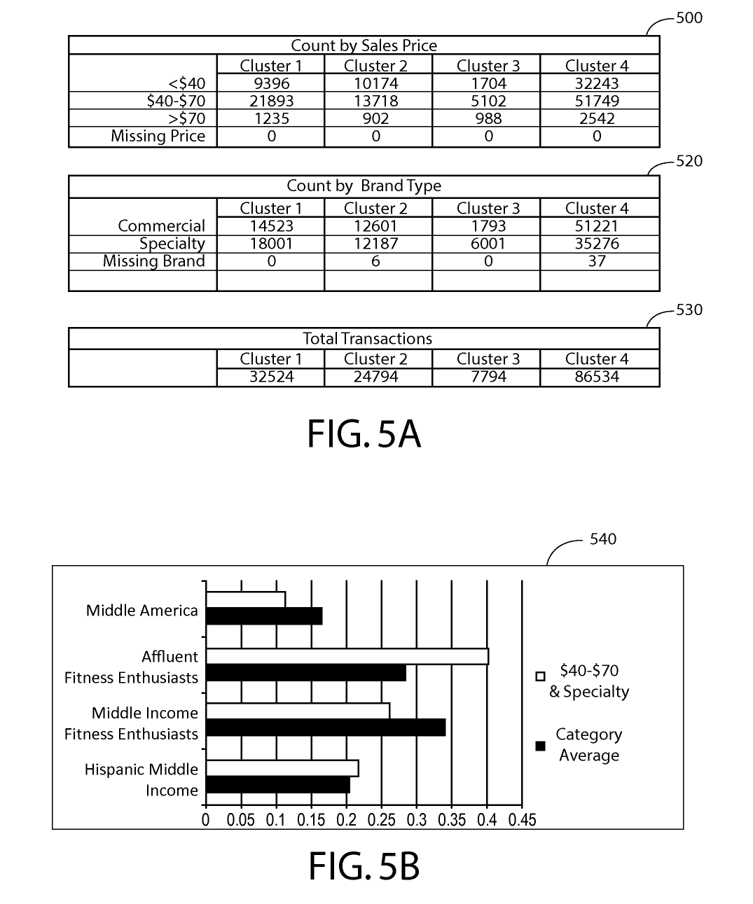

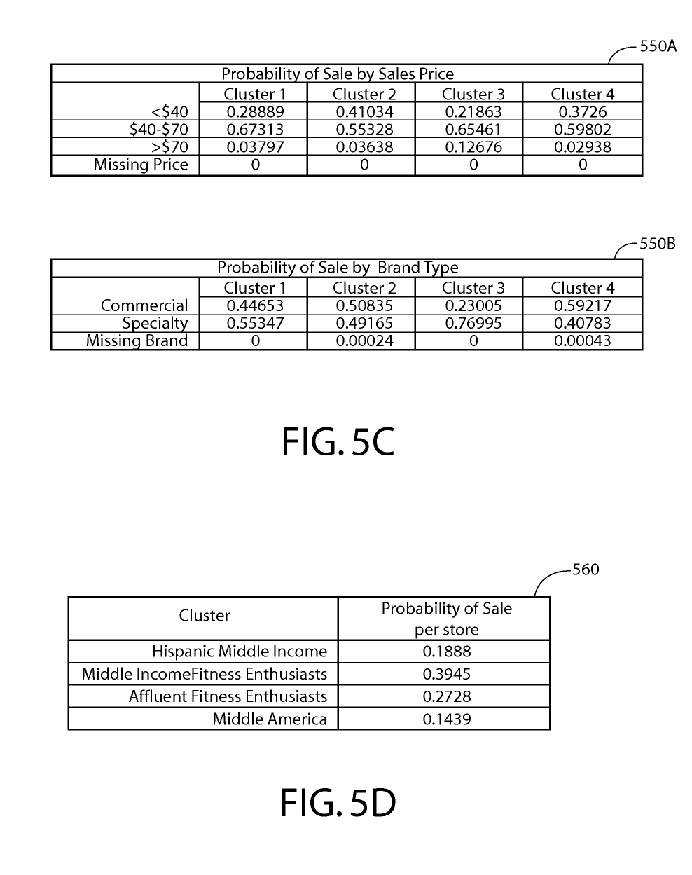

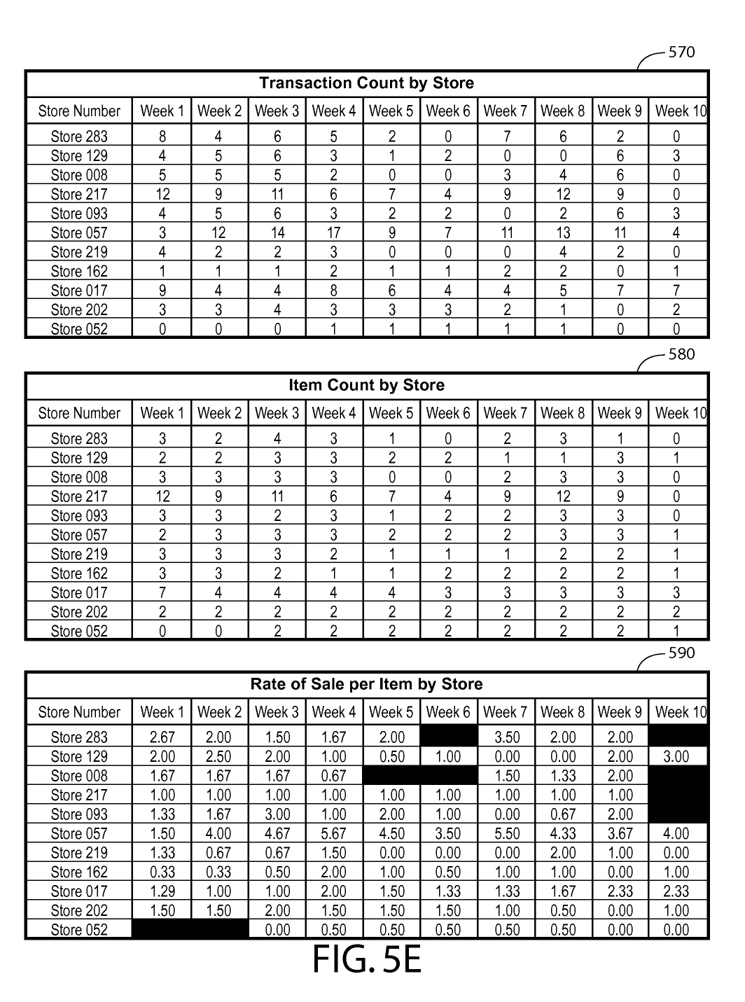

FIGS. 5A-5E are diagrams illustrating a set of product attribute sales summaries and information associated with the set of product attribute sales summaries according to at least one example embodiment. The examples of FIGS. 5A-5E are merely examples and do not limit the scope of the claims. For example, product attribute sales summary configuration and/or content may vary, customer store segment count may vary, product attribute count may vary, graph configuration and/or content may vary, product sales prediction table configuration and/or content may vary, and/or the like.

As discussed regarding FIGS. 4A-4C, a merchant may desire to sell men's athletic shoes. The set of three customer attributes discussed regarding FIGS. 4A-4C, annual household income, percentage Hispanic, and age, may fail to provide a sufficient basis for a customer store segment sales model due to a lack of distinctiveness, a low level of information gain resulting from analysis of chart 440 of FIG. 4B, and/or the like. As such, it may be desirable to analyze one or more additional sets of customer attributes in relation to the sale of men's athletic shoes. For example, as discussed in the previous example, a set of three customer attributes may be used to characterize male customers of men's athletic shoes: annual household income, percentage Hispanic, and age. In some circumstances, it may be desirable to pursue analysis of various combinations of customer attributes, product attributes, and/or the like. For example, replacing the age-related customer attribute with a lifestyle-related customer attribute may yield interesting and useful results in relation to sales of men's athletic shoes. The lifestyle-related customer attribute may be a customer attribute that indicates a measure of community fitness. For example, survey data that indicates an average level of health and fitness for a specific zip code may be referenced by way of the residential zip code that is indicated in loyalty account information.

In such an example, the set of customer attributes may comprise an annual household income, a percentage Hispanic, and a community fitness rank. The annual household income may indicate a household income of less than $50,000, $50,000-$80,000, or greater than $80,000. The percentage Hispanic may indicate a percentage that is less than 5%, 5%-15%, or greater than 15%. The community fitness rank may indicate value ranges of 1-15, 16-30, and greater than 30. In such an example, the set of product attributes may comprise a price point and a band type. The price point may indicate that a pair of men's athletic shoes are priced under $40, $40-$70, or greater than $70. The brand type may indicate that the pair of men's athletic shoes are of the commercial type or the specialty type. As such, four customer store segments may be identified—cluster 1, which is characterized by “Hispanic Middle Income” and comprises 29 stores, cluster 2, which is characterized by “Middle Income Fitness Enthusiasts” and comprises 63 stores, cluster 3, which is characterized by “Affluent Fitness Enthusiasts” and comprises 11 stores, and cluster 4, which is characterized by “Middle America” and comprises 209 stores.

FIG. 5A is a diagram illustrating a set of product attribute sales summaries according to at least one example embodiment. As can be seen, FIG. 5A depicts product attribute sales summary 500 and product attribute sales summary 520. Each of product attribute sales summary 500 and product attribute sales summary 520 correlate clusters 1, 2, 3, and 4, which are customer store segments, and various product attributes, to the indicated quantity of sales data. For example, product attribute sales summary 500 indicates that 13718 men's athletic shoes in the $40-$70 price range were sold in cluster 2, and that 1235 men's athletic shoes in the greater than $70 price range were sold in cluster 1. In another example, product attribute sales summary 520 indicates that 14523 men's athletic shoes of the commercial type were sold in cluster 1, and that 6001 men's athletic shoes of the specialty type were sold in cluster 3. As can be seen, the example of FIG. 5A also depicts table 530, which indicates a total quantity of sales of men's athletic shoes across all product attributes and purchased by all customers within an indicated customer store segment. For example, table 530 indicates that 32524 pairs of men's athletic shoes were sold in cluster 1, and 86534 men's athletic shoes were sold in cluster 4.

FIG. 5B is a diagram illustrating a chart associated with a set of product attribute sales summaries according to at least one example embodiment. The example of FIG. 5B corresponds with the product attribute sales summaries depicted in the example of FIG. 5A. As can be seen, chart 540 depicts sales of men's athletic shoes that are in the $40-$70 price range and of the specialty type with respect to a “Middle America” customer store segment, an “Affluent Fitness Enthusiasts” customer store segment, a “Middle Income Fitness Enthusiasts” customer store segment, and a “Hispanic Middle Income” customer store segment. The usefulness of the results may be evaluated visually by charting the results for specific combinations of product attributes with respect to the respective customer store segment, as shown in chart 540. As can be seen, chart 540 depicts the probabilities of sale for each customer store segment for men's athletic shoes that are associated with the indicated product attributes. As can be seen, the resulting probabilities significant different from the probabilities indicated by the category average in at least two of the customer store segments. As such, a distinctiveness rating associated with the product attribute sales summary associated with chart 540 may be higher than another product attribute sales summary that fails to yield interesting and/or useful results.

Analysis of chart 540 supports the forming of various inferences. For example, it can be seen that, on average, stores in the “Affluent Fitness Enthusiasts” customer store segment will likely sell the particular type of men's athletic shoe—specialty shoes in the $40-$70 price range—better than all other stores in the set of stores and all other customer store segments, and specifically, that sales will likely exceed the sales performance of stores in the “Middle Income Fitness Enthusiasts” customer store segment, despite the “Middle Income Fitness Enthusiasts” customer store segment having greater total sales for the men's athletic shoe category as a whole. As can be seen, a distinctiveness rating associated with the set of product attribute sales summaries represented by chart 540 of FIG. 5B would likely be higher than a distinctiveness rating associated with the set of product attribute sales summaries represented by chart 440 of FIG. 4B. As such, it may be more desirable to determine a customer store segment sales model based, at least in part, on the set of product attribute sales summaries represented by chart 540 of FIG. 5B.

FIG. 5C is a diagram illustrating a set of product attribute probability of sale summaries according to at least one example embodiment. As can be seen, FIG. 5C depicts product attribute probability of sale summary 550A and product attribute probability of sale summary 550B, which correspond to product attribute sales summary 500 and product attribute sales summary 520 of FIG. 5A, respectively. Each of product attribute probability of sale summary 550A and product attribute probability of sale summary 550B correlate clusters 1, 2, 3, and 4, which are customer store segments, and various product attributes, to the indicated probability of sale data. For example, product attribute probability of sale summary 550A indicates a probability of sale of 0.28889 for products that are associated with a sales price of under $40 within cluster 1. In another example, product attribute probability of sale summary 550A indicates a probability of sale of 0.49165 for products that are of the specialty brand type in cluster 2.

FIG. 5D is a diagram illustrating a product sales prediction table according to at least one example embodiment. The example of FIG. 5D depicts product sales prediction table 560. Product sales prediction table 560 may be based, at least in part, on a set of product attribute sales summaries, a customer store segment sales model, and/or the like. In the example of FIG. 5D, product sales prediction table 560 depicts a set of probabilities of sales associated with a particular set of customer store segments. As can be seen, the “Hispanic Middle Income” customer store segment is associated with a 0.188 probability of sale, the “Middle Income Fitness Enthusiasts” customer store segment is associated with a 0.3945 probability of sale, the “Affluent Fitness Enthusiasts” customer store segment is associated with a 0.2728 probability of sale, and the “Middle America” customer store segment is associated with a 0.1439 probability of sale. As such, given a sale of a pair of men's athletic shoes, product sales prediction table 460 indicates a probability that the specific sale took place at each of the indicated customer store segments. In this manner, a merchant may utilize such information in determining how to allot the merchant's inventory of men's athletic shoes among the merchant's stores, between the various customer stores segments, and/or the like.

FIG. 5E is a diagram illustrating a quantity of sales summary, an inventory summary, and a rate of sale summary according to at least one example embodiment. The example of FIG. 5E depicts a set of historical sales information summaries. In the example of FIG. 5E, the set of historical sales information summaries comprises quantity of sales summary 570, inventory summary 580, and rate of sale summary 590. As can be seen in quantity of sales summary 570, the quantity of sales data is a quantity of sales attributable to a specific store, a specific customer store segment, and/or the like, over a predetermined duration. For example, quantity of sales summary 570 indicates a quantity of sale of 11 is attributable to store 217 over week 3. Quantity of sales summary 570 further indicates that 6 transactions took place at store 217 the following week, week 4.

As can be seen in inventory summary 580, the inventory data is a count of inventory that is attributable to a specific store, a specific customer store segment, and/or the like, over a predetermined duration. For example, inventory summary 580 indicates that store 217 had 9 items associated with the particular product attribute(s) in stock during week 9. Inventory summary 580 further indicates that store 217 ran out of stock the following week, week 10.

As can be seen in rate of sale summary 590, the rate of sale data is a rate of sale that is attributable to a specific store, a specific customer store segment, and/or the like, over a predetermined duration. For example, rate of sale summary 590 indicates that store 570 had a rate of sale of 1.50 during week 1, but increased to a rate of sale of 5.67 by week 4.

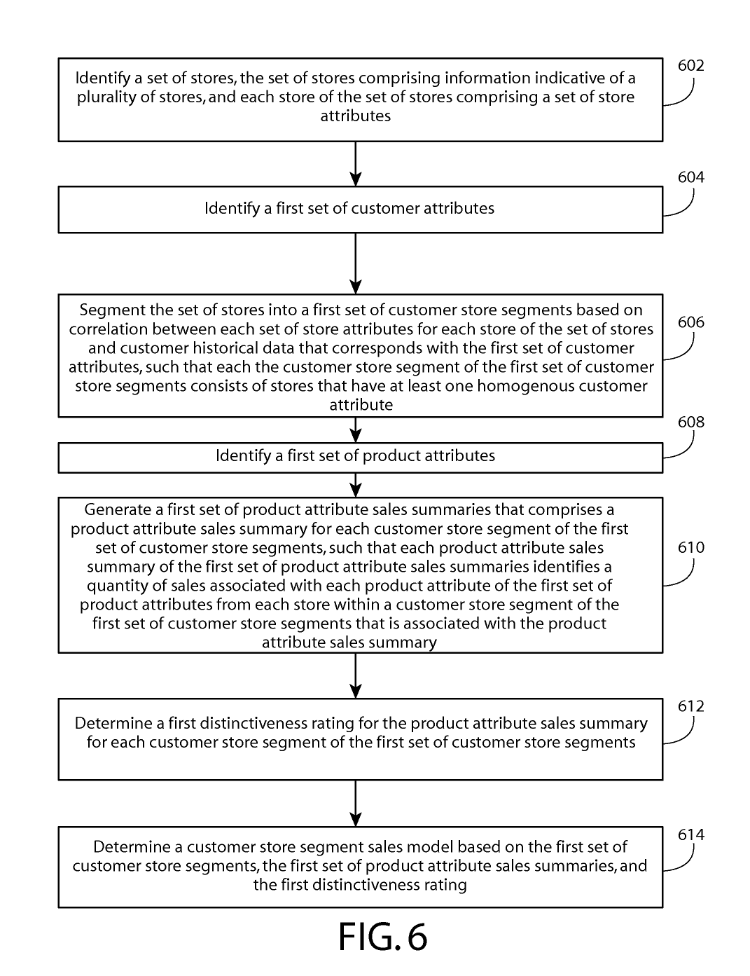

FIG. 6 is a flow diagram illustrating activities associated with determination of a customer store segment sales model according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

At block 602, the apparatus identifies a set of stores. In at least one example embodiment, the set of stores comprises information indicative of a plurality of stores, and each store of the set of stores comprises a set of store attributes. The identification, the set of stores, the plurality of stores, and the set of store attributes may be similar as described regarding FIGS. 2A-2B, FIGS. 3A-3E, FIGS. 4A-4C, and FIGS. 5A-5E.

At block 604, the apparatus identifies a first set of customer attributes. The identification and the first set of customer attributes may be similar as described regarding FIGS. 2A-2B, FIGS. 3A-3E, FIGS. 4A-4C, and FIGS. 5A-5E.

At block 606, the apparatus segments the set of stores into a first set of customer store segments based, at least in part, on correlation between each set of store attributes for each store of the set of stores and customer historical data that corresponds with the first set of customer attributes. In at least one example embodiment, the apparatus segments the set of stores into the first set of customer store segments such that each the customer store segment of the first set of customer store segments consists of stores that have at least one homogenous customer attribute. The segmentation, the first set of customer store segments, the customer historical data, and the homogenous customer attribute may be similar as described regarding FIGS. 2A-2B, FIGS. 3A-3E, FIGS. 4A-4C, and FIGS. 5A-5E.

At block 608, the apparatus identifies a first set of product attributes. The identification and the first set of product attributes may be similar as described regarding FIGS. 3A-3E, FIGS. 4A-4C, and FIGS. 5A-5E.

At block 610, the apparatus generates a first set of product attribute sales summaries that comprises a product attribute sales summary for each customer store segment of the first set of customer store segments. In at least one example embodiment, the apparatus generates the first set of product attribute sales summaries such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries. The generation, the first set of product attribute sales summaries, the product attribute sales summary, and the quantity of sales may be similar as described regarding FIGS. 3A-3E, FIGS. 4A-4C, and FIGS. 5A-5E.

At block 612, the apparatus determines a first distinctiveness rating for the product attribute sales summary for each customer store segment of the first set of customer store segments. The determination and the first distinctiveness rating may be similar as described regarding FIGS. 3A-3E, FIGS. 4A-4C, and FIGS. 5A-5E.

At block 614, the apparatus determines a customer store segment sales model based, at least in part, on the first set of customer store segments, the first set of product attribute sales summaries, and the first distinctiveness rating. The determination and the customer store segment sales model may be similar as described regarding FIGS. 3A-3E, FIGS. 4A-4C, and FIGS. 5A-5E.

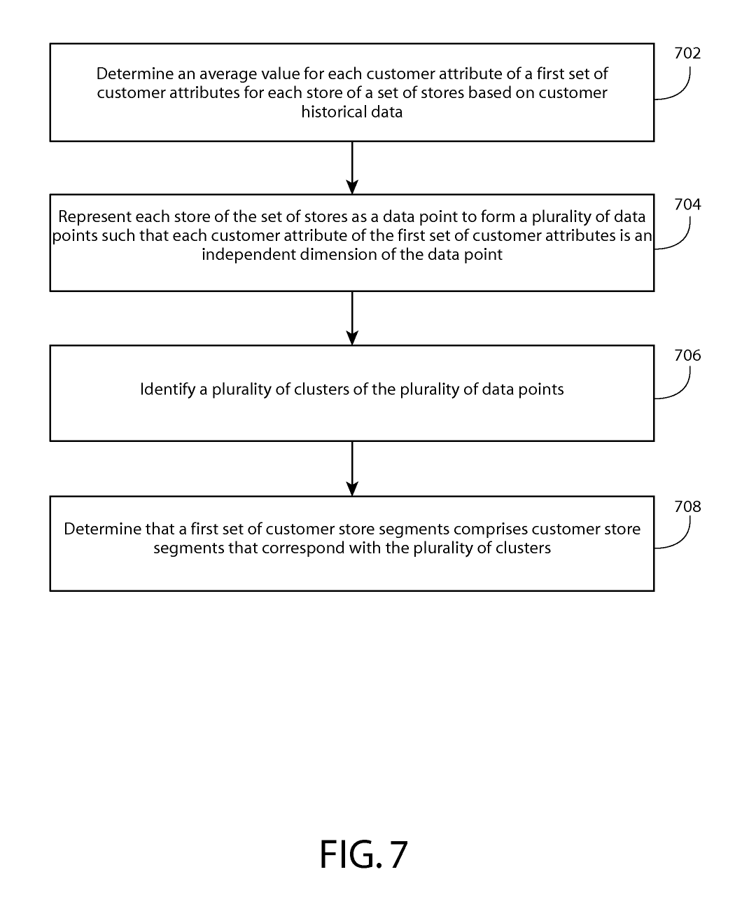

FIG. 7 is a flow diagram illustrating activities associated with identification of a plurality of clusters according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

In some circumstances, it may be desirable to segment a set of stores into a set of customer store segments based, at least in part, on a set of customer attributes. As such, the activities illustrated in the example of FIG. 7 may be performed in relation to the activities illustrated in the example of FIG. 6. For example, the activities illustrated in the example of FIG. 7 may be performed prior to the activity illustrated in block 606 of FIG. 6, subsequent to the activity illustrated in block 606 of FIG. 6, in lieu of the activity illustrated in block 606 of FIG. 6, and/or the like.

At block 702, the apparatus determines an average value for each customer attribute of a first set of customer attributes for each store of a set of stores based, at least in part, on customer historical data. The determination, the average value for each customer attribute, the first set of customer attributes, the store, and the set of stores may be similar as described regarding FIGS. 2A-2B, FIGS. 3A-3E, FIGS. 4A-4C, and FIGS. 5A-5E.

At block 704, the apparatus represents each store of the set of stores as a data point to form a plurality of data points such that each customer attribute of the first set of customer attributes is an independent dimension of the data point. The representation, the data point, the plurality of data points, and the independent dimension of the data point may be similar as described regarding FIGS. 2A-2B, FIGS. 3A-3E, FIGS. 4A-4C, and FIGS. 5A-5E.

At block 706, the apparatus identifies a plurality of clusters of the plurality of data points. The identification and the plurality of clusters may be similar as described regarding FIGS. 2A-2B, FIGS. 3A-3E, FIGS. 4A-4C, and FIGS. 5A-5E.

At block 708, the apparatus determines that a first set of customer store segments comprises customer store segments that correspond with the plurality of clusters. The determination and the first set of customer store segments may be similar as described regarding FIGS. 2A-2B, FIGS. 3A-3E, FIGS. 4A-4C, and FIGS. 5A-5E.

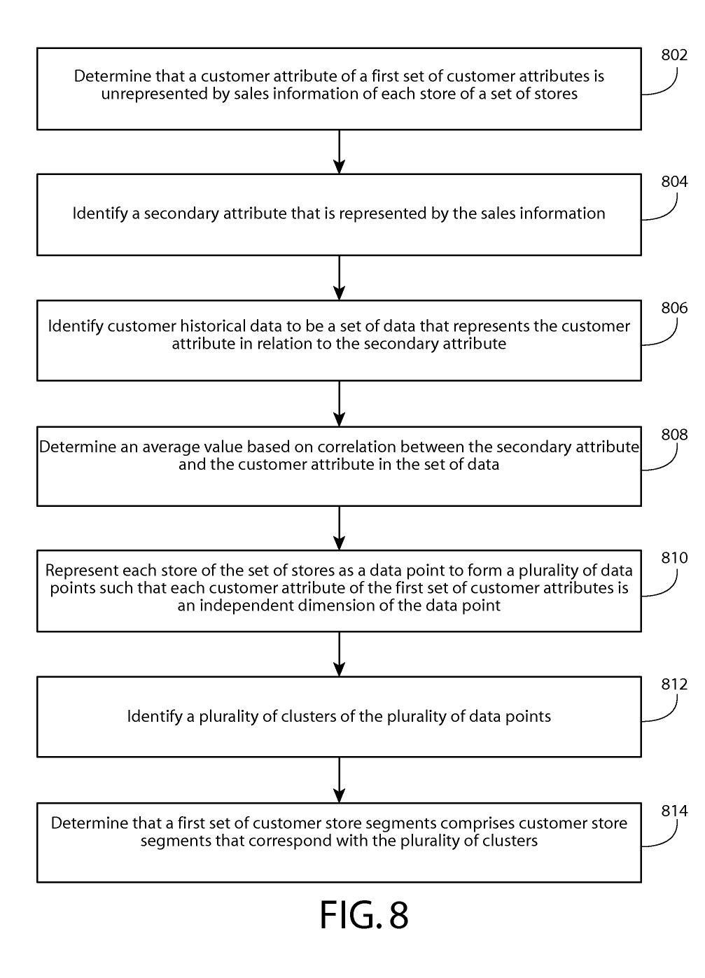

FIG. 8 is a flow diagram illustrating activities associated with identification of a plurality of clusters according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

In some circumstances, it may be desirable to determine an average value for each customer attribute of a set of customer attributes based, at least in part, on customer historical data. As such, the activities illustrated in the example of FIG. 8 may be performed in relation to the activities illustrated in the example of FIG. 7. For example, the activities illustrated in the example of FIG. 8 may be performed prior to the activity illustrated in block 702 of FIG. 7, subsequent to the activity illustrated in block 702 of FIG. 7, in lieu of the activity illustrated in block 702 of FIG. 7, and/or the like.

At block 802, the apparatus determines that a customer attribute of a first set of customer attributes is unrepresented by sales information of each store of a set of stores. The determination, the customer attribute, the first set of customer attributes, the sales information of each store, and the set of stores may be similar as described regarding FIGS. 2A-2B, FIGS. 3A-3E, FIGS. 4A-4C, and FIGS. 5A-5E.

At block 804, the apparatus identifies a secondary attribute that is represented by the sales information. The identification and the secondary attribute may be similar as described regarding FIGS. 2A-2B, FIGS. 3A-3E, FIGS. 4A-4C, and FIGS. 5A-5E.

At block 806, the apparatus identifies customer historical data to be a set of data that represents the customer attribute in relation to the secondary attribute. The identification, the customer historical data, and the set of data may be similar as described regarding FIGS. 2A-2B, FIGS. 3A-3E, FIGS. 4A-4C, and FIGS. 5A-5E.

At block 808, the apparatus determines an average value based, at least in part, on correlation between the secondary attribute and the customer attribute in the set of data. The determination and the average value may be similar as described regarding FIGS. 2A-2B, FIGS. 3A-3E, FIGS. 4A-4C, and FIGS. 5A-5E.

At block 810, the apparatus represents each store of the set of stores as a data point to form a plurality of data points such that each customer attribute of the first set of customer attributes is an independent dimension of the data point. The representation, the data point, the plurality of data points, and the independent dimension of the data point may be similar as described regarding FIGS. 2A-2B, FIGS. 3A-3E, FIGS. 4A-4C, and FIGS. 5A-5E.

At block 812, the apparatus identifies a plurality of clusters of the plurality of data points. The identification and the plurality of clusters may be similar as described regarding FIGS. 2A-2B, FIGS. 3A-3E, FIGS. 4A-4C, and FIGS. 5A-5E.

At block 814, the apparatus determines that a first set of customer store segments comprises customer store segments that correspond with the plurality of clusters. The determination and the first set of customer store segments may be similar as described regarding FIGS. 2A-2B, FIGS. 3A-3E, FIGS. 4A-4C, and FIGS. 5A-5E.

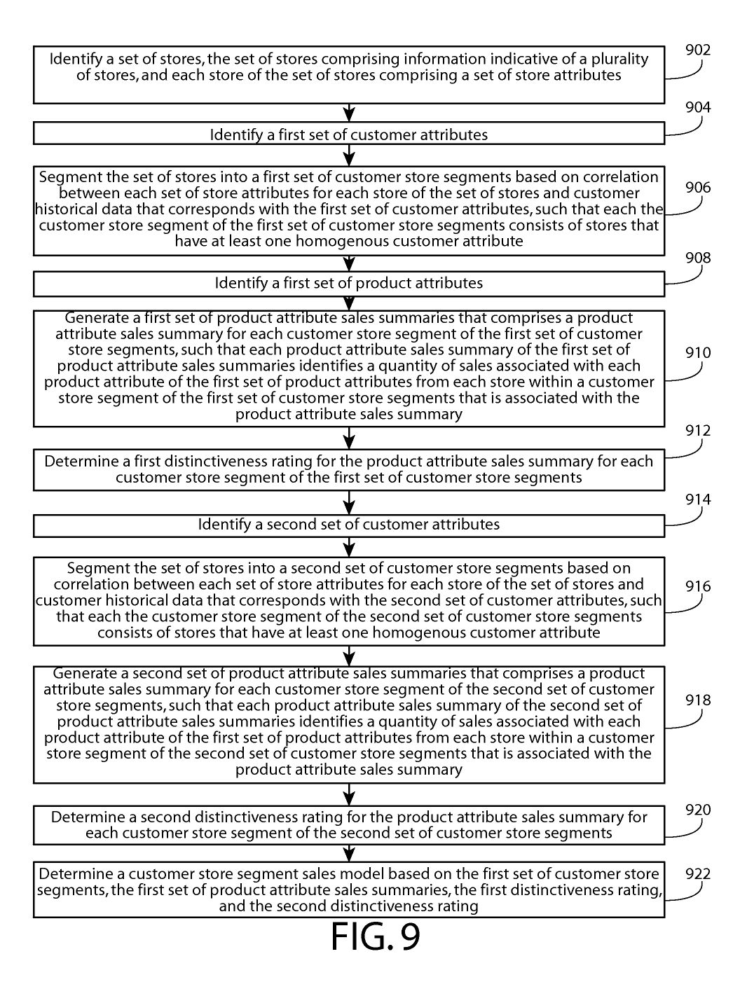

FIG. 9 is a flow diagram illustrating activities associated with determination of a customer store segment sales model according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

As previously discussed, in some circumstances, it may be desirable to determine a customer store segment sales model based, at least in part, on a first set of product attribute sales summaries and an associated first distinctiveness rating, and a second set of product attribute sales summaries and an associated second distinctiveness rating.

At block 902, the apparatus identifies a set of stores. In at least one example embodiment, the set of stores comprises information indicative of a plurality of stores, and each store of the set of stores comprises a set of store attributes. The identification, the set of stores, the plurality of stores, and the set of store attributes may be similar as described regarding FIGS. 2A-2B, FIGS. 3A-3E, FIGS. 4A-4C, and FIGS. 5A-5E.

At block 904, the apparatus identifies a first set of customer attributes. The identification and the first set of customer attributes may be similar as described regarding FIGS. 2A-2B, FIGS. 3A-3E, FIGS. 4A-4C, and FIGS. 5A-5E.

At block 906, the apparatus segments the set of stores into a first set of customer store segments based, at least in part, on correlation between each set of store attributes for each store of the set of stores and customer historical data that corresponds with the first set of customer attributes. In at least one example embodiment, the apparatus segments the set of stores into the first set of customer store segments such that each the customer store segment of the first set of customer store segments consists of stores that have at least one homogenous customer attribute. The segmentation, the first set of customer store segments, the customer historical data, and the homogenous customer attribute may be similar as described regarding FIGS. 2A-2B, FIGS. 3A-3E, FIGS. 4A-4C, and FIGS. 5A-5E.

At block 908, the apparatus identifies a first set of product attributes. The identification and the first set of product attributes may be similar as described regarding FIGS. 3A-3E, FIGS. 4A-4C, and FIGS. 5A-5E.

At block 910, the apparatus generates a first set of product attribute sales summaries that comprises a product attribute sales summary for each customer store segment of the first set of customer store segments. In at least one example embodiment, the apparatus generates the first set of product attribute sales summaries such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries. The generation, the first set of product attribute sales summaries, the product attribute sales summary, and the quantity of sales may be similar as described regarding FIGS. 3A-3E, FIGS. 4A-4C, and FIGS. 5A-5E.

At block 912, the apparatus determines a first distinctiveness rating for the product attribute sales summary for each customer store segment of the first set of customer store segments. The determination and the first distinctiveness rating may be similar as described regarding FIGS. 3A-3E, FIGS. 4A-4C, and FIGS. 5A-5E.

At block 914, the apparatus identifies a second set of customer attributes. The identification and the second set of customer attributes may be similar as described regarding FIGS. 2A-2B, FIGS. 3A-3E, FIGS. 4A-4C, and FIGS. 5A-5E.

At block 916, the apparatus segments the set of stores into a second set of customer store segments based, at least in part, on correlation between each set of store attributes for each store of the set of stores and customer historical data that corresponds with the second set of customer attributes. In at least one example embodiment, the apparatus segments the set of stores into the first set of customer store segments such that each the customer store segment of the second set of customer store segments consists of stores that have at least one homogenous customer attribute. The segmentation, the second set of customer store segments, the customer historical data, and the homogenous customer attribute may be similar as described regarding FIGS. 2A-2B, FIGS. 3A-3E, FIGS. 4A-4C, and FIGS. 5A-5E.

At block 918, the apparatus generates a second set of product attribute sales summaries that comprises a product attribute sales summary for each customer store segment of the second set of customer store segments. In at least one example embodiment, the apparatus generates the second set of product attribute sales summaries such that each product attribute sales summary of the second set of product attribute sales summaries identifies a quantity of sales associated with each product attribute of the first set of product attributes from each store within a customer store segment of the second set of customer store segments that is associated with the product attribute sales summary of the second set of product attribute sales summaries. The generation, the second set of product attribute sales summaries, the product attribute sales summary, and the quantity of sales may be similar as described regarding FIGS. 3A-3E, FIGS. 4A-4C, and FIGS. 5A-5E.

At block 920, the apparatus determines a second distinctiveness rating for the product attribute sales summary for each customer store segment of the second set of customer store segments. The determination and the second distinctiveness rating may be similar as described regarding FIGS. 3A-3E, FIGS. 4A-4C, and FIGS. 5A-5E.

At block 922, the apparatus determines a customer store segment sales model based, at least in part, on the first set of customer store segments, the first set of product attribute sales summaries, the first distinctiveness rating, and the second distinctiveness rating. The determination and the customer store segment sales model may be similar as described regarding FIGS. 3A-3E, FIGS. 4A-4C, and FIGS. 5A-5E.

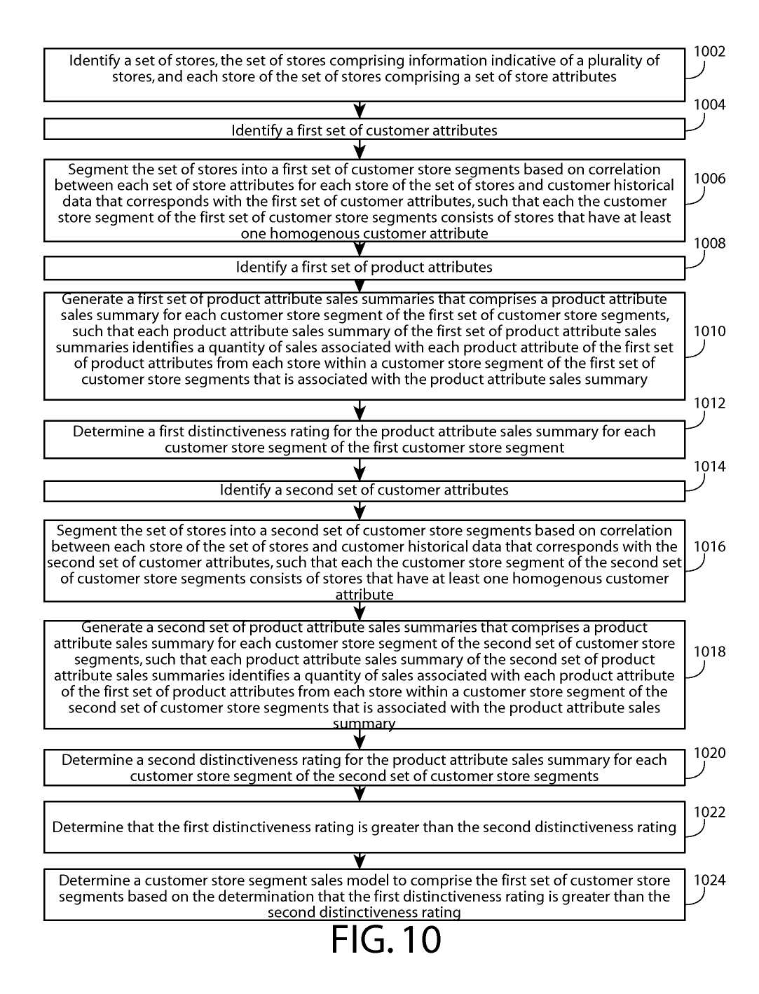

FIG. 10 is a flow diagram illustrating activities associated with determination of a customer store segment sales model according to at least one example embodiment. In at least one example embodiment, there is a set of operations that corresponds with the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 10.

As previously discussed, in some circumstances, it may be desirable to determine a first distinctiveness rating that is associated with a first set of customer store segments, and a second distinctiveness rating that is associated with a second set of customer store segments. In such an example, it may be desirable to determine a customer store segment sales model to comprise the set of customer store segments that is associated with the greater distinctiveness rating.

At block 1002, the apparatus identifies a set of stores. In at least one example embodiment, the set of stores comprises information indicative of a plurality of stores, and each store of the set of stores comprises a set of store attributes. The identification, the set of stores, the plurality of stores, and the set of store attributes may be similar as described regarding FIGS. 2A-2B, FIGS. 3A-3E, FIGS. 4A-4C, and FIGS. 5A-5E.

At block 1004, the apparatus identifies a first set of customer attributes. The identification and the first set of customer attributes may be similar as described regarding FIGS. 2A-2B, FIGS. 3A-3E, FIGS. 4A-4C, and FIGS. 5A-5E.

At block 1006, the apparatus segments the set of stores into a first set of customer store segments based, at least in part, on correlation between each set of store attributes for each store of the set of stores and customer historical data that corresponds with the first set of customer attributes. In at least one example embodiment, the apparatus segments the set of stores into the first set of customer store segments such that each the customer store segment of the first set of customer store segments consists of stores that have at least one homogenous customer attribute. The segmentation, the first set of customer store segments, the customer historical data, and the homogenous customer attribute may be similar as described regarding FIGS. 2A-2B, FIGS. 3A-3E, FIGS. 4A-4C, and FIGS. 5A-5E.

At block 1008, the apparatus identifies a first set of product attributes. The identification and the first set of product attributes may be similar as described regarding FIGS. 3A-3E, FIGS. 4A-4C, and FIGS. 5A-5E.

At block 1010, the apparatus generates a first set of product attribute sales summaries that comprises a product attribute sales summary for each customer store segment of the first set of customer store segments. In at least one example embodiment, the apparatus generates the first set of product attribute sales summaries such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries. The generation, the first set of product attribute sales summaries, the product attribute sales summary, and the quantity of sales may be similar as described regarding FIGS. 3A-3E, FIGS. 4A-4C, and FIGS. 5A-5E.

At block 1012, the apparatus determines a first distinctiveness rating for the product attribute sales summary for each customer store segment of the first set of customer store segments. The determination and the first distinctiveness rating may be similar as described regarding FIGS. 3A-3E, FIGS. 4A-4C, and FIGS. 5A-5E.

At block 1014, the apparatus identifies a second set of customer attributes. The identification and the second set of customer attributes may be similar as described regarding FIGS. 2A-2B, FIGS. 3A-3E, FIGS. 4A-4C, and FIGS. 5A-5E.

At block 1016, the apparatus segments the set of stores into a second set of customer store segments based, at least in part, on correlation between each set of store attributes for each store of the set of stores and customer historical data that corresponds with the second set of customer attributes. In at least one example embodiment, the apparatus segments the set of stores into the first set of customer store segments such that each the customer store segment of the second set of customer store segments consists of stores that have at least one homogenous customer attribute. The segmentation, the second set of customer store segments, the customer historical data, and the homogenous customer attribute may be similar as described regarding FIGS. 2A-2B, FIGS. 3A-3E, FIGS. 4A-4C, and FIGS. 5A-5E.

At block 1018, the apparatus generates a second set of product attribute sales summaries that comprises a product attribute sales summary for each customer store segment of the second set of customer store segments. In at least one example embodiment, the apparatus generates the second set of product attribute sales summaries such that each product attribute sales summary of the second set of product attribute sales summaries identifies a quantity of sales associated with each product attribute of the first set of product attributes from each store within a customer store segment of the second set of customer store segments that is associated with the product attribute sales summary of the second set of product attribute sales summaries. The generation, the second set of product attribute sales summaries, the product attribute sales summary, and the quantity of sales may be similar as described regarding FIGS. 3A-3E, FIGS. 4A-4C, and FIGS. 5A-5E.

At block 1020, the apparatus determines a second distinctiveness rating for the product attribute sales summary for each customer store segment of the second set of customer store segments. The determination and the second distinctiveness rating may be similar as described regarding FIGS. 3A-3E, FIGS. 4A-4C, and FIGS. 5A-5E.

At block 1022, the apparatus determines that the first distinctiveness rating is greater than the second distinctiveness rating. The determination may be similar as described regarding FIGS. 3A-3E, FIGS. 4A-4C, and FIGS. 5A-5E.

At block 1024, the apparatus determines a customer store segment sales model to comprise the first set of customer store segments based, at least in part, on the determination that the first distinctiveness rating is greater than the second distinctiveness rating. The determination and the customer store segment sales model may be similar as described regarding FIGS. 3A-3E, FIGS. 4A-4C, and FIGS. 5A-5E.

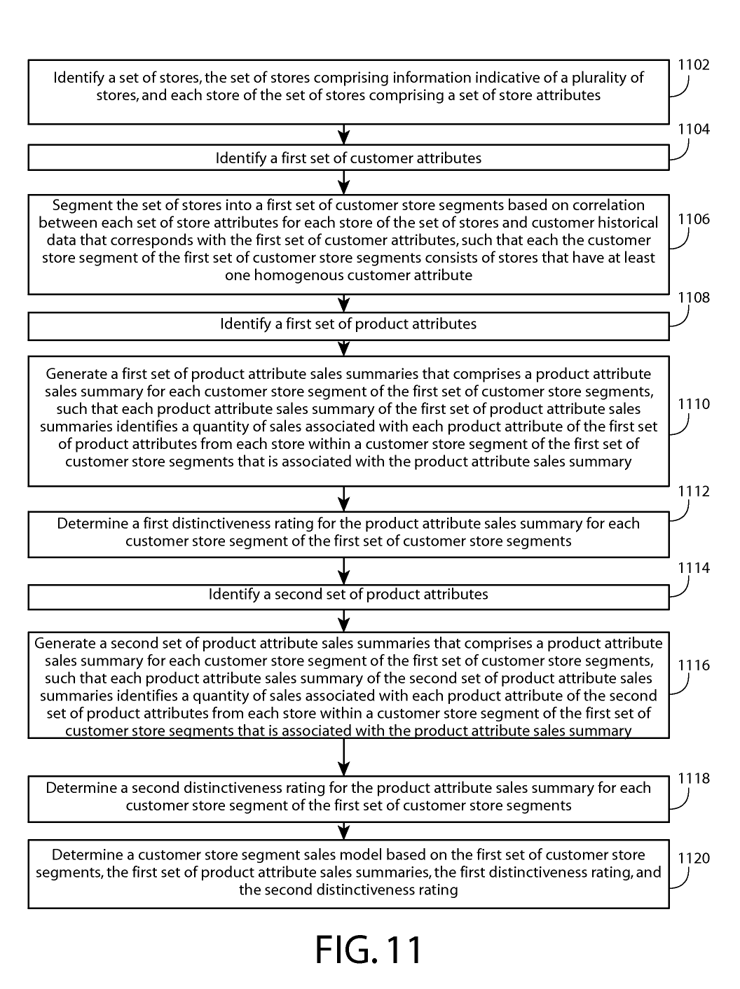

FIG. 11 is a flow diagram illustrating activities associated with determination of a customer store segment sales model according to at least one example embodiment. In at least one example embodiment, there is a set of operations that corresponds with the activities of FIG. 11. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 11.

As previously discussed, in some circumstances, it may be desirable to determine a first distinctiveness rating that is associated with a first set of product attribute sales summaries, and a second distinctiveness rating that is associated with a second set of product attribute sales summaries. In such an example, it may be desirable to determine a customer store segment sales model based, at least in part, on the first distinctiveness rating and the second distinctiveness rating.

At block 1102, the apparatus identifies a set of stores. In at least one example embodiment, the set of stores comprises information indicative of a plurality of stores, and each store of the set of stores comprises a set of store attributes. The identification, the set of stores, the plurality of stores, and the set of store attributes may be similar as described regarding FIGS. 2A-2B, FIGS. 3A-3E, FIGS. 4A-4C, and FIGS. 5A-5E.

At block 1104, the apparatus identifies a first set of customer attributes. The identification and the first set of customer attributes may be similar as described regarding FIGS. 2A-2B, FIGS. 3A-3E, FIGS. 4A-4C, and FIGS. 5A-5E.

At block 1106, the apparatus segments the set of stores into a first set of customer store segments based, at least in part, on correlation between each set of store attributes for each store of the set of stores and customer historical data that corresponds with the first set of customer attributes. In at least one example embodiment, the apparatus segments the set of stores into the first set of customer store segments such that each the customer store segment of the first set of customer store segments consists of stores that have at least one homogenous customer attribute. The segmentation, the first set of customer store segments, the customer historical data, and the homogenous customer attribute may be similar as described regarding FIGS. 2A-2B, FIGS. 3A-3E, FIGS. 4A-4C, and FIGS. 5A-5E.

At block 1108, the apparatus identifies a first set of product attributes. The identification and the first set of product attributes may be similar as described regarding FIGS. 3A-3E, FIGS. 4A-4C, and FIGS. 5A-5E.

At block 1110, the apparatus generates a first set of product attribute sales summaries that comprises a product attribute sales summary for each customer store segment of the first set of customer store segments. In at least one example embodiment, the apparatus generates the first set of product attribute sales summaries such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries. The generation, the first set of product attribute sales summaries, the product attribute sales summary, and the quantity of sales may be similar as described regarding FIGS. 3A-3E, FIGS. 4A-4C, and FIGS. 5A-5E.

At block 1112, the apparatus determines a first distinctiveness rating for the product attribute sales summary for each customer store segment of the first set of customer store segments. The determination and the first distinctiveness rating may be similar as described regarding FIGS. 3A-3E, FIGS. 4A-4C, and FIGS. 5A-5E.

At block 1114, the apparatus identifies a second set of product attributes. The identification and the second set of product attributes may be similar as described regarding FIGS. 3A-3E, FIGS. 4A-4C, and FIGS. 5A-5E.

At block 1116, the apparatus generates a second set of product attribute sales summaries that comprises a product attribute sales summary for each customer store segment of the first set of customer store segments. In at least one example embodiment, the apparatus generates the second set of product attribute sales summaries such that each product attribute sales summary of the second set of product attribute sales summaries identifies a quantity of sales associated with each product attribute of the second set of product attributes from each store within a customer store segment of the first set of customer store segments that is associated with the product attribute sales summary of the second set of product attribute sales summaries. The generation, the second set of product attribute sales summaries, the product attribute sales summary, and the quantity of sales may be similar as described regarding FIGS. 3A-3E, FIGS. 4A-4C, and FIGS. 5A-5E.

At block 1118, the apparatus determines a second distinctiveness rating for the product attribute sales summary for each customer store segment of the first set of customer store segments. The determination and the second distinctiveness rating may be similar as described regarding FIGS. 3A-3E, FIGS. 4A-4C, and FIGS. 5A-5E.

At block 1120, the apparatus determines a customer store segment sales model based, at least in part, on the first set of customer store segments, the first set of product attribute sales summaries, the first distinctiveness rating, and the second distinctiveness rating. The determination and the customer store segment sales model may be similar as described regarding FIGS. 3A-3E, FIGS. 4A-4C, and FIGS. 5A-5E.

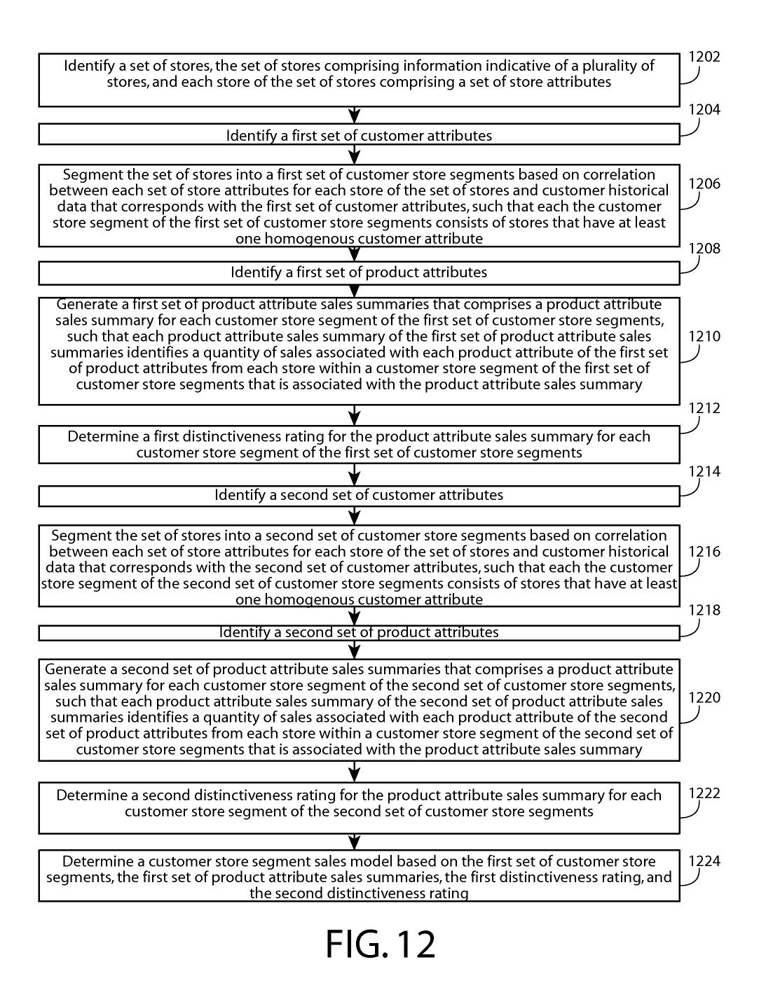

FIG. 12 is a flow diagram illustrating activities associated with determination of a customer store segment sales model according to at least one example embodiment. In at least one example embodiment, there is a set of operations that corresponds with the activities of FIG. 12. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 12.

As previously discussed, in some circumstances, it may be desirable to determine a first distinctiveness rating that is associated with a first set of customer store segments and a first set of product attribute sales summaries, and a second distinctiveness rating that is associated with a second set of customer store segments and a second set of product attribute sales summaries. In such an example, it may be desirable to determine a customer store segment sales model based, at least in part, on the first distinctiveness rating and the second distinctiveness rating.

At block 1202, the apparatus identifies a set of stores. In at least one example embodiment, the set of stores comprises information indicative of a plurality of stores, and each store of the set of stores comprises a set of store attributes. The identification, the set of stores, the plurality of stores, and the set of store attributes may be similar as described regarding FIGS. 2A-2B, FIGS. 3A-3E, FIGS. 4A-4C, and FIGS. 5A-5E.

At block 1204, the apparatus identifies a first set of customer attributes. The identification and the first set of customer attributes may be similar as described regarding FIGS. 2A-2B, FIGS. 3A-3E, FIGS. 4A-4C, and FIGS. 5A-5E.

At block 1206, the apparatus segments the set of stores into a first set of customer store segments based, at least in part, on correlation between each set of store attributes for each store of the set of stores and customer historical data that corresponds with the first set of customer attributes. In at least one example embodiment, the apparatus segments the set of stores into the first set of customer store segments such that each the customer store segment of the first set of customer store segments consists of stores that have at least one homogenous customer attribute. The segmentation, the first set of customer store segments, the customer historical data, and the homogenous customer attribute may be similar as described regarding FIGS. 2A-2B, FIGS. 3A-3E, FIGS. 4A-4C, and FIGS. 5A-5E.

At block 1208, the apparatus identifies a first set of product attributes. The identification and the first set of product attributes may be similar as described regarding FIGS. 3A-3E, FIGS. 4A-4C, and FIGS. 5A-5E.

At block 1210, the apparatus generates a first set of product attribute sales summaries that comprises a product attribute sales summary for each customer store segment of the first set of customer store segments. In at least one example embodiment, the apparatus generates the first set of product attribute sales summaries such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries. The generation, the first set of product attribute sales summaries, the product attribute sales summary, and the quantity of sales may be similar as described regarding FIGS. 3A-3E, FIGS. 4A-4C, and FIGS. 5A-5E.

At block 1212, the apparatus determines a first distinctiveness rating for the product attribute sales summary for each customer store segment of the first set of customer store segments. The determination and the first distinctiveness rating may be similar as described regarding FIGS. 3A-3E, FIGS. 4A-4C, and FIGS. 5A-5E.

At block 1214, the apparatus identifies a second set of customer attributes. The identification and the second set of customer attributes may be similar as described regarding FIGS. 2A-2B, FIGS. 3A-3E, FIGS. 4A-4C, and FIGS. 5A-5E.

At block 1216, the apparatus segments the set of stores into a second set of customer store segments based, at least in part, on correlation between each set of store attributes for each store of the set of stores and customer historical data that corresponds with the second set of customer attributes. In at least one example embodiment, the apparatus segments the set of stores into the first set of customer store segments such that each the customer store segment of the second set of customer store segments consists of stores that have at least one homogenous customer attribute. The segmentation, the second set of customer store segments, the customer historical data, and the homogenous customer attribute may be similar as described regarding FIGS. 2A-2B, FIGS. 3A-3E, FIGS. 4A-4C, and FIGS. 5A-5E.

At block 1218, the apparatus identifies a second set of product attributes. The identification and the second set of product attributes may be similar as described regarding FIGS. 3A-3E, FIGS. 4A-4C, and FIGS. 5A-5E.

At block 1220, the apparatus generates a second set of product attribute sales summaries that comprises a product attribute sales summary for each customer store segment of the first set of customer store segments. In at least one example embodiment, the apparatus generates the second set of product attribute sales summaries such that each product attribute sales summary of the second set of product attribute sales summaries identifies a quantity of sales associated with each product attribute of the second set of product attributes from each store within a customer store segment of the first set of customer store segments that is associated with the product attribute sales summary of the second set of product attribute sales summaries. The generation, the second set of product attribute sales summaries, the product attribute sales summary, and the quantity of sales may be similar as described regarding FIGS. 3A-3E, FIGS. 4A-4C, and FIGS. 5A-5E.

At block 1222, the apparatus determines a second distinctiveness rating for the product attribute sales summary for each customer store segment of the second set of customer store segments. The determination and the second distinctiveness rating may be similar as described regarding FIGS. 3A-3E, FIGS. 4A-4C, and FIGS. 5A-5E.

At block 1224, the apparatus determines a customer store segment sales model based, at least in part, on the first set of customer store segments, the first set of product attribute sales summaries, the first distinctiveness rating, and the second distinctiveness rating. The determination and the customer store segment sales model may be similar as described regarding FIGS. 3A-3E, FIGS. 4A-4C, and FIGS. 5A-5E.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 608 of FIG. 6 may be performed before block 606 of FIG. 6. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. An apparatus, comprising:
at least one processor;
at least one memory including computer program code, the memory and the computer program code configured to, working with the processor, cause the apparatus to perform at least the following:
identification of a set of stores, the set of stores comprising information indicative of a plurality of stores, and each store of the set of stores comprising a set of store attributes;
identification of a first set of customer attributes;
segmentation of the set of stores into a first set of customer store segments based, at least in part, on correlation between each set of store attributes for each store of the set of stores and customer historical data that corresponds with the first set of customer attributes, such that each the customer store segment of the first set of customer store segments consists of stores that have at least one homogenous customer attribute;
identification of a first set of product attributes;
generation of a first set of product attribute sales summaries that comprises a product attribute sales summary for each customer store segment of the first set of customer store segments, such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries;
determination of a first distinctiveness rating for the product attribute sales summary for each customer store segment of the first set of customer store segments; and
determination of a customer store segment sales model based, at least in part, on the first set of customer store segments, the first set of product attribute sales summaries, and the first distinctiveness rating.

2. The apparatus of claim 1, wherein the identification of the quantity of sales associated with each product attribute of the first set of product attributes comprises grouping of products into a set of products that are associated with the product attribute, and determination of the quantity of sales associated with the set of products.

3. The apparatus of claim 1, wherein the segmentation of the set of stores into the first set of customer store segments comprises:
determination of an average value for each customer attribute of the first set of customer attributes for each store of the set of stores based, at least in part, on the customer historical data;
representation of each store of the set of stores as a data point to form a plurality of data points such that each customer attribute of the first set of customer attributes is an independent dimension of the data point;
identification of a plurality of clusters of the plurality of data points; and
determination that the first set of customer store segments comprises customer store segments that correspond with the plurality of clusters.

4. The apparatus of claim 3, wherein the determination of the average value for each customer attribute of the first set of customer attributes comprises:
determination that a customer attribute of the first set of customer attributes is unrepresented by sales information of each store of the set of stores;
identification of a secondary attribute that is represented by the sales information;
identification of the customer historical data to be a set of data that represents the customer attribute in relation to the secondary attribute; and
determination of the average value based, at least in part, on correlation between the secondary attribute and the customer attribute in the set of data.

5. The apparatus of claim 1, wherein the memory includes computer program code configured to, working with the processor, cause the apparatus to perform:
identification of a second set of customer attributes;
segmentation of the set of stores into a second set of customer store segments based, at least in part, on correlation between each set of store attributes for each store of the set of stores and customer historical data that corresponds with the second set of customer attributes, such that each the customer store segment of the second set of customer store segments consists of stores that have at least one homogenous customer attribute;
generation of a second set of product attribute sales summaries that comprises a product attribute sales summary for each customer store segment of the second set of customer store segments, such that each product attribute sales summary of the second set of product attribute sales summaries identifies a quantity of sales associated with each product attribute of the first set of product attributes from each store within a customer store segment of the second set of customer store segments that is associated with the product attribute sales summary of the second set of product attribute sales summaries; and
determination of a second distinctiveness rating for the product attribute sales summary for each customer store segment of the second set of customer store segments, wherein the determination of a customer store segment sales model is based, at least in part, on the second distinctiveness rating.

6. The apparatus of claim 5, wherein the determination of the customer store segment sales model comprises:
determination that the first distinctiveness rating is greater than the second distinctiveness rating; and
determination of the customer store segment sales model to comprise the first set of customer store segments based, at least in part, on the determination that the first distinctiveness rating is greater than the second distinctiveness rating.

7. The apparatus of claim 1, wherein the memory includes computer program code configured to, working with the processor, cause the apparatus to perform:
identification of a second set of product attributes;
generation of a second set of product attribute sales summaries that comprises a product attribute sales summary for each customer store segment of the first set of customer store segments, such that each product attribute sales summary of the second set of product attribute sales summaries identifies a quantity of sales associated with each product attribute of the second set of product attributes from each store within a customer store segment of the first set of customer store segments that is associated with the product attribute sales summary; and
determination of a second distinctiveness rating for the product attribute sales summary for each customer store segment of the first set of customer store segments, wherein the determination of a customer store segment sales model is based, at least in part, on the second distinctiveness rating.

8. The apparatus of claim 1, wherein the memory includes computer program code configured to, working with the processor, cause the apparatus to perform:
identification of a second set of customer attributes;
segmentation of the set of stores into a second set of customer store segments based, at least in part, on correlation between each set of store attributes for each store of the set of stores and customer historical data that corresponds with the second set of customer attributes, such that each customer store segment of the second set of customer store segments consists of stores that have at least one homogenous customer attribute;
identification of a second set of product attributes;
generation of a second set of product attribute sales summaries that comprises a product attribute sales summary for each customer store segment of the second set of customer store segments, such that each product attribute sales summary of the second set of product attribute sales summaries identifies a quantity of sales associated with each product attribute of the second set of product attributes from each store within a customer store segment of the second set of customer store segments that is associated with the product attribute sales summary; and
determination of a second distinctiveness rating for the product attribute sales summary for each customer store segment of the second set of customer store segments, wherein the determination of a customer store segment sales model is based, at least in part, on the second distinctiveness rating.

9. The apparatus of claim 1, wherein the apparatus comprises a display.

10. A method comprising:
identifying a set of stores, the set of stores comprising information indicative of a plurality of stores, and each store of the set of stores comprising a set of store attributes;
identifying a first set of customer attributes;
segmenting the set of stores into a first set of customer store segments based, at least in part, on correlation between each set of store attributes for each store of the set of stores and customer historical data that corresponds with the first set of customer attributes, such that each the customer store segment of the first set of customer store segments consists of stores that have at least one homogenous customer attribute;
identifying a first set of product attributes;
generating a first set of product attribute sales summaries that comprises a product attribute sales summary for each customer store segment of the first set of customer store segments, such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries;
determining a first distinctiveness rating for the product attribute sales summary for each customer store segment of the first set of customer store segments; and
determining a customer store segment sales model based, at least in part, on the first set of customer store segments, the first set of product attribute sales summaries, and the first distinctiveness rating.

11. The method of claim 10, wherein the segmentation of the set of stores into the first set of customer store segments comprises:
determining an average value for each customer attribute of the first set of customer attributes for each store of the set of stores based, at least in part, on the customer historical data;
representing each store of the set of stores as a data point to form a plurality of data points such that each customer attribute of the first set of customer attributes is an independent dimension of the data point;
identifying a plurality of clusters of the plurality of data points; and
determining that the first set of customer store segments comprises customer store segments that correspond with the plurality of clusters.

12. The method of claim 11, wherein the determination of the average value for each customer attribute of the first set of customer attributes comprises:
determining that a customer attribute of the first set of customer attributes is unrepresented by sales information of each store of the set of stores;
identifying a secondary attribute that is represented by the sales information;
identifying the customer historical data to be a set of data that represents the customer attribute in relation to the secondary attribute; and
determining the average value based, at least in part, on correlation between the secondary attribute and the customer attribute in the set of data.

13. The method of claim 10, further comprising:
identifying a second set of customer attributes;
segmenting the set of stores into a second set of customer store segments based, at least in part, on correlation between each set of store attributes for each store of the set of stores and customer historical data that corresponds with the second set of customer attributes, such that each the customer store segment of the second set of customer store segments consists of stores that have at least one homogenous customer attribute;
generating a second set of product attribute sales summaries that comprises a product attribute sales summary for each customer store segment of the second set of customer store segments, such that each product attribute sales summary of the second set of product attribute sales summaries identifies a quantity of sales associated with each product attribute of the first set of product attributes from each store within a customer store segment of the second set of customer store segments that is associated with the product attribute sales summary of the second set of product attribute sales summaries; and
determining a second distinctiveness rating for the product attribute sales summary for each customer store segment of the second set of customer store segments, wherein the determination of a customer store segment sales model is based, at least in part, on the second distinctiveness rating.

14. The method of claim 13, wherein the determination of the customer store segment sales model comprises:
determining that the first distinctiveness rating is greater than the second distinctiveness rating; and
determining the customer store segment sales model to comprise the first set of customer store segments based, at least in part, on the determination that the first distinctiveness rating is greater than the second distinctiveness rating.

15. The method of claim 10, further comprising:
identifying a second set of product attributes;
generating a second set of product attribute sales summaries that comprises a product attribute sales summary for each customer store segment of the first set of customer store segments, such that each product attribute sales summary of the second set of product attribute sales summaries identifies a quantity of sales associated with each product attribute of the second set of product attributes from each store within a customer store segment of the first set of customer store segments that is associated with the product attribute sales summary; and
determining a second distinctiveness rating for the product attribute sales summary for each customer store segment of the first set of customer store segments, wherein the determination of a customer store segment sales model is based, at least in part, on the second distinctiveness rating.

16. The method of claim 10, further comprising:
identifying a second set of customer attributes;
segmenting the set of stores into a second set of customer store segments based, at least in part, on correlation between each set of store attributes for each store of the set of stores and customer historical data that corresponds with the second set of customer attributes, such that each customer store segment of the second set of customer store segments consists of stores that have at least one homogenous customer attribute;
identifying a second set of product attributes;
generating a second set of product attribute sales summaries that comprises a product attribute sales summary for each customer store segment of the second set of customer store segments, such that each product attribute sales summary of the second set of product attribute sales summaries identifies a quantity of sales associated with each product attribute of the second set of product attributes from each store within a customer store segment of the second set of customer store segments that is associated with the product attribute sales summary; and
determining a second distinctiveness rating for the product attribute sales summary for each customer store segment of the second set of customer store segments, wherein the determination of a customer store segment sales model is based, at least in part, on the second distinctiveness rating.

17. At least one computer-readable medium encoded with instructions that, when executed by a processor, perform:
identification of a set of stores, the set of stores comprising information indicative of a plurality of stores, and each store of the set of stores comprising a set of store attributes;
identification of a first set of customer attributes;
segmentation of the set of stores into a first set of customer store segments based, at least in part, on correlation between each set of store attributes for each store of the set of stores and customer historical data that corresponds with the first set of customer attributes, such that each the customer store segment of the first set of customer store segments consists of stores that have at least one homogenous customer attribute;
identification of a first set of product attributes;
generation of a first set of product attribute sales summaries that comprises a product attribute sales summary for each customer store segment of the first set of customer store segments, such that each product attribute sales summary of the first set of product attribute sales summaries identifies a quantity of sales associated with each product attribute of the first set of product attributes from each store within a customer store segment of the first set of customer store segments that is associated with the product attribute sales summary of the first set of product attribute sales summaries;
determination of a first distinctiveness rating for the product attribute sales summary for each customer store segment of the first set of customer store segments; and
determination of a customer store segment sales model based, at least in part, on the first set of customer store segments, the first set of product attribute sales summaries, and the first distinctiveness rating.

18. The medium of claim 17, further encoded with instructions that, when executed by a processor, perform:
identification of a second set of customer attributes;
segmentation of the set of stores into a second set of customer store segments based, at least in part, on correlation between each set of store attributes for each store of the set of stores and customer historical data that corresponds with the second set of customer attributes, such that each the customer store segment of the second set of customer store segments consists of stores that have at least one homogenous customer attribute;
generation of a second set of product attribute sales summaries that comprises a product attribute sales summary for each customer store segment of the second set of customer store segments, such that each product attribute sales summary of the second set of product attribute sales summaries identifies a quantity of sales associated with each product attribute of the first set of product attributes from each store within a customer store segment of the second set of customer store segments that is associated with the product attribute sales summary of the second set of product attribute sales summaries; and
determination of a second distinctiveness rating for the product attribute sales summary for each customer store segment of the second set of customer store segments, wherein the determination of a customer store segment sales model is based, at least in part, on the second distinctiveness rating.

19. The medium of claim 17, further encoded with instructions that, when executed by a processor, perform:
identification of a second set of product attributes;
generation of a second set of product attribute sales summaries that comprises a product attribute sales summary for each customer store segment of the first set of customer store segments, such that each product attribute sales summary of the second set of product attribute sales summaries identifies a quantity of sales associated with each product attribute of the second set of product attributes from each store within a customer store segment of the first set of customer store segments that is associated with the product attribute sales summary; and
determination of a second distinctiveness rating for the product attribute sales summary for each customer store segment of the first set of customer store segments, wherein the determination of a customer store segment sales model is based, at least in part, on the second distinctiveness rating.

20. The medium of claim 17, further encoded with instructions that, when executed by a processor, perform:
identification of a second set of customer attributes;
segmentation of the set of stores into a second set of customer store segments based, at least in part, on correlation between each set of store attributes for each store of the set of stores and customer historical data that corresponds with the second set of customer attributes, such that each customer store segment of the second set of customer store segments consists of stores that have at least one homogenous customer attribute;
identification of a second set of product attributes;
generation of a second set of product attribute sales summaries that comprises a product attribute sales summary for each customer store segment of the second set of customer store segments, such that each product attribute sales summary of the second set of product attribute sales summaries identifies a quantity of sales associated with each product attribute of the second set of product attributes from each store within a customer store segment of the second set of customer store segments that is associated with the product attribute sales summary; and
determination of a second distinctiveness rating for the product attribute sales summary for each customer store segment of the second set of customer store segments, wherein the determination of a customer store segment sales model is based, at least in part, on the second distinctiveness rating.
